(19) United States
(12) Patent Application Publication
(10) Pub. No.: US 2004/0193474 A1
(43) Pub. Date: Sep. 30, 2004

(54) Estimating, costing, and installation system for home renovation projects and tree-based profit distribution system

(76) Inventor: Carl Digiacomo, Windsor (CA)

Correspondence Address: LERNER AND GREENBERG, PA, P O BOX 2480, HOLLYWOOD, FL, 33022-2480, US

(21) Appl. No.: 10/403,535

(22) Filed: Mar. 31, 2003

(51) Int. Cl. G06F 17/60

(52) U.S. Cl. 705/9

(57) ABSTRACT

An estimating, costing, and installation system for home renovation projects includes estimation modules for a user-specified home renovation project. A simple query system enables the DIYer to estimate a detailed quantity of material required for their home project, to receive a detailed cost report based on local supplier prices, to receive a detailed graphic layout of the material to be used and how it is installed, and to receive a tool requirement list that takes into account tools already possessed by the DIYer. The system provides local contractors and budgeted prices for the project. The system software is stored in a central location secured through firewalls by a hosting service. The databases that contain all the information for the costing of materials, tools, equipment, and budgeting labor are maintained through a local zonal administrator distribution network. Also provided is a tree-based profit distribution system applying the system.

### BACKGROUND OF THE INVENTION

1. Field of the Invention

The invention lies in the fields of home renovations, Internet-based systems, and the business of distributing profits. The invention relates to an estimating, costing, and installation system for home renovation projects and tree-based profit distribution system.

2. Description of the Related Art

A review of the construction industry over the past thirty years reveals a specific area that is becoming a major market for manufacturers, suppliers, and small contractors. This evolving market is the home renovation market, also referred to as the Do-It-Yourselfer (“DIYer”). Large supply companies and building material centers are expending large amounts of capital investment to educate the DIYer in the use of construction materials and in the erection of construction projects to capture more of a market share. In 2001, news agencies reported that out of approximately 450 billion dollars spent on construction materials in the United States, the DIYers spent 125 billion dollars. Some of the underlying reasons for this continually growing 27+% share of the market place are apparent: there are more home owners now than at anytime in the history of the United States; and middle income families cannot afford to hire contractors for small projects because the labor portion of the contract has become cost prohibitive. Therefore, the DIYer has decided to do these projects on their own. Self-help videotapes, various do-it-yourself construction television shows, and numerous magazines and texts have made it simple for the DIYers to become competent in the proper installation procedures of the various construction disciplines. Tool and equipment technology has also advanced to a level where the DIYer is more than comfortable with their use for the installation of the products on which they are working. Missing from this formula, however, is the proper estimation and costing of the material, tools, and equipment required for the home renovation projects. Also missing is a budget cost amount for situations where the DIYer would prefer to have a contractor perform the labor.

A review of the bookkeeping and accounting software as it pertains to the corporate portion of the construction industry reveals numerous bookkeeping and accounting software that are available for the corporate user. The primary use of such software is to track a company's payables and receivables, and to authorize payments of and issue checks to accounts payable and payroll. The method of requesting payments is usually accomplished by issuing invoices through mailings (with occasional backups through facsimile) to the customers. The method of payment can take any number of forms, i.e., checks through the mail or bank transfers. Received payments are, then, banked and registered as a receivable from the specific paying client account. The method of continual tracking for such a system is usually done in arrears, with a minimum of thirty days wait for reception of receivables.

### SUMMARY OF THE INVENTION

The relevant DIYer projects are those that are, typically, using anywhere between one to four disciplines at one time, i.e., insulation, drywall, painting, etc. Under such circumstances, the DIYer will be exposed to the building material suppliers and the suppliers' material estimation system, which, usually, is an individual that is hired by a particular material supplier to estimate the material requirements for the DIYer. This type of estimation has met with varying degrees of success due to numerous criteria, for example, skill level of the estimator, knowledge of the discipline, etc. The DIYer can also use some of the material calculators that are prevalent throughout the industries (on the Internet, palm held calculators, etc.) for getting volumes, linear footages, and square footages for use by the material suppliers for supply of the required materials to the DIYer. All of the above considerations have left a substantial number of the DIYers with either too much material and substantial waste or too little material and the need for the DIYer to go back to the supplier numerous times to get the required amount of material for their project.

The present invention provides software estimating programs for estimating, costing, etc., that might have been used in the general construction industry, but, now, can be used by the DIYer. In the development, several important factors were addressed, specifically, ease of use by the DIYer, cost. to the DIYer, cost to the material supplier, and a general access for all of the participants. Some of the advantages produced by the estimation system include better accuracy of estimating programs with numeric formulas and graphical interfaces, ease of use, and savings in material for subcontractors.

The estimation system according to the present invention can be used at a supplier's store or at the DIYer's residence or any other location, depending on the DIYer's particular preference.

Two other major areas of concern to the DIYer have become apparent: tool and equipment requirements for the home renovation project; and whether or not the DIYer wanted to hire some one else for the labor portions of the project and, therefore, what would be a budget price for that labor.

Simply put, these concerns are formulated with the following questions that would be asked by a DIYer: What materials do I require to do my project? What will that material cost be? What tools do I require and what is the cost? What equipment do I require and what is the cost? What will a contractor cost to do the labor if I require it? If I want to use a contractor for my project, how do I find him and is that contractor qualified?

The estimation system answers each of these questions for the DIYer.

FIG. 1 is a flow diagram illustrating the complete interaction of the overall estimation system for the DIYer to obtain estimates for material requirements and cost, tool requirements and cost, equipment requirements and cost, and contractor contacts and labor cost. The estimation system is a complete system, interacting with databases for acquiring the requisite information for the DIYer through a query system, sometimes referred to as an expert system, that filters all of the necessary information from the databases to insure that the DIYer has the proper materials, tools, and equipment and is provided with a cost for each. The estimation system completes these tasks through a series of structured questions and numeric formulas that are used with a corresponding room shape selected by the DIYer. In specific instances, the invention will also provide the DIYer with a graphic drawing showing the installation of some of the modular material the DIYer has chosen, for example, installation of drywall. Correspondingly, the DIYer will receive a graphic layout material installation design in any applicable module.

In a drywall installation, for example, the graphic engine of the system shows the DIYer the dimensions that the DIYer is required to cut each sheet of drywall (if any), numbers the pieces (cut and uncut) by sheet, and graphically shows where those numbered pieces should be placed on their respective walls, the graphical illustration looking somewhat like a jigsaw puzzle.

The summary information input by the DIYer interacts with the databases and is distributed to the requisite report databases. The report databases are connected to the local supplier material, tool, and equipment cost database and the contractor labor cost database, each of which is overseen by a Zonal Administrator, which will be described in more detail below with regard to the method of doing business according to the invention. The reports are issued through a printer with the cover page showing manufacturer/supplier of the requisite material with its respective specification and, on a separate page, the estimated amount of material, its estimated cost, and its graphic layout (where applicable in the specified graphic modules). The material suppliers can, if they wish, tie quantity estimates into their own point of sale software for invoicing the DIYer. Two other reports that are issued with the same parameters are those of tool and equipment supply and cost and the contractor's names with a budgeted cost for their respective labor.

The vehicle for enabling omni-locational use of the estimation system by the DIYer is the Internet. Thus, access to the estimation system can be accomplished from any computer having access to the Internet, whether through telephone lines, cable systems, wireless networks, or satellite. The majority of the DIYers, however, will most likely access the estimation system from their respective residence or local supplier.

The present invention also provides a unique method for conducting a business utilizing the construction estimation system according to the invention. The method includes dissemination of information, monitoring of databases, local corporate interaction with suppliers, contractors/subcontractors, and Internet users, and local financial maintenance. Each of these functions are performed by what are referred to as a Regional Administrator and a Zonal Administrator, and the overall system is maintained through the Internet on secured channels with programs for continual daily tracking of payment and receivables.

Other features that are considered as characteristic for the invention are set forth in the appended claims.

Although the invention is illustrated and described herein as embodied in a do-it-yourselfer estimating, costing, and installation system for home renovation projects and tree-based profit distribution system, it is, nevertheless, not intended to be limited to the details shown because various modifications and structural changes may be made therein without departing from the spirit of the invention and within the scope and range of equivalents of the claims.

### BRIEF DESCRIPTION OF THE DRAWINGS

The features of the estimation system and method according to the invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a flow diagram illustrating interaction of the overall estimation system according to the invention for a DIYer to obtain estimates for materials, tools, and equipment and costs thereof and estimates for cost of labor;

FIG. 2 is a diagrammatic illustration of an opening input screen for selecting estimation modules according to the invention;

FIG. 3 is a diagrammatic illustration of an input screen for defining a DIYer painting project;

FIG. 4 is a diagrammatic illustration of a wall painting input screen for defining the painting project of FIG. 3;

FIG. 5 is a diagrammatic illustration of a ceiling painting input screen for defining the painting project of FIG. 3;

FIG. 6 is a diagrammatic illustration of a room shape input screen for defining the painting project of FIG. 3;

FIG. 7 is a diagrammatic illustration of a room wall specifications input screen for defining the painting project of FIG. 3;

FIG. 8 is a diagrammatic illustration of a room paint specification input screen for defining the painting project of FIG. 3;

FIG. 9 is a diagrammatic illustration of a door specifications input screen for defining the painting project of FIG. 3;

FIG. 10 is a diagrammatic illustration of a window specifications input screen for defining the painting project of FIG. 3;

FIG. 11 is a diagrammatic illustration of a ceiling specifications input screen for defining the painting project of FIG. 3;

FIG. 12 is a diagrammatic illustration of an equipment checklist input screen for defining the painting project of FIG. 3;

FIG. 13 is a diagrammatic illustration of a room type database according to the invention;

FIG. 14 is a diagrammatic illustration of a graphical room shape database according to the invention;

FIG. 15 is a diagrammatic illustration of a room shape database with formulas according to the invention for calculating ceiling area for a respective room shape;

FIG. 16 is a diagrammatic illustration of another portion of the room shape database of FIG. 15;

FIG. 17 is a diagrammatic illustration of a wall specification summary sheet produced according to the invention for the painting project of FIG. 3 taking into consideration opening deductions of trim and door requirements;

FIG. 18 is a table illustrating a database for door and arch specifications according to the invention;

FIG. 19 is table illustrating a database for window specifications according to the invention;

FIG. 20 is a list of text describing a database of formulas according to the invention for determining quantity of paint needed for walls, trim, doors, windows, and ceilings;

FIG. 21 is a diagrammatic illustration of a database report screen of prime and finish coats for wall painting according to the invention;

FIG. 22 is a diagrammatic illustration of a database report screen of prime and finish coats for wall trim painting according to the invention;

FIG. 23 is a diagrammatic illustration of a database report screen of prime and finish coats for ceiling painting according to the invention;

FIG. 24 is a diagrammatic illustration of a database report screen of prime and finish coats for ceiling trim painting according to the invention;

FIG. 25 is a diagrammatic illustration of a database report screen of prime and finish coats for window frame painting according to the invention;

FIG. 26 is a diagrammatic illustration of a database report screen of prime and finish coats for window trim painting according to the invention;

FIG. 27 is a diagrammatic illustration of a database report screen of prime and finish coats for door painting according to the invention;

FIG. 28 is a diagrammatic illustration of a database report screen of prime and finish coats for door trim painting according to the invention;

FIG. 29 is a list of text describing triggers for accessing the tools and equipment databases according to the invention;

FIG. 30 is a diagrammatic illustration of a database report screen according to the invention for tools and equipment needed;

FIG. 31 is a diagrammatic illustration of a database input screen according to the invention for painting tools and equipment;

FIG. 32 is a diagrammatic illustration of a paint database report screen according to the invention;

FIG. 33 is a flow chart illustrating the organization of corporate entities for the method according to the invention;

FIG. 34 is a diagrammatic illustration of a database spreadsheet according to the invention for material suppliers in a region;

FIG. 35 is a diagrammatic illustration of a database spreadsheet according to the invention for subcontractors in a region;

FIG. 36 is a flowchart illustrating a fee collection schedule according to the invention;

FIG. 37 is a flowchart illustrating a corporate structure of the system according to the invention;

FIG. 38 is a flowchart illustrating a reporting system according to the invention;

FIG. 39 is a diagrammatic illustration of a monthly supplier report according to the invention;

FIG. 40 is a diagrammatic illustration of a monthly zonal report according to the invention;

FIG. 41 is a diagrammatic illustration of a monthly zonal report according to the invention for direct home access by a DIYer;

FIG. 42 is a diagrammatic illustration of a monthly report according to the invention relating to a contractor with hosting provided;

FIG. 43 is a diagrammatic illustration of a monthly report according to the invention relating to a contractor;

FIG. 44 is a diagrammatic illustration of a monthly regional administrator report according to the invention; and

FIG. 45 is a diagrammatic illustration of a monthly head office report according to the invention.

### DESCRIPTION OF THE PREFERRED EMBODIMENTS

While the specification concludes with claims defining the features of the invention that are regarded as novel, it is believed that the invention will be better understood from a consideration of the following description in conjunction with the drawing figures, in which like reference numerals are carried forward.

In the construction industry, there are a number of relevant facts that have to be addressed by a contractor in order to start and complete a project. Among these facts are the different types of construction that are going to give the client the best possible value for an invested dollar. The optimal way to analyze what is best for the client from a cost perspective is to be knowledgeable about the materials that can be used on any specific project. That knowledge has to be accompanied by a precise understanding of the quantities of the materials that are required (i.e., how the quantities are arrived at or are estimated) and the cost for those materials. Once the quantity of material required is estimated, it has to be assigned a relevant cost, which will complete the material quantity and cost portion of the project for the contractor. The next step is to ascertain what the labor cost will be for the installation of the material that was estimated. In almost all cases, the labor cost is calculated by knowing the quantity of each material that is involved and whether the quantity is by volume (i.e., cubic yard, gallon, etc.) or by area (i.e., square yard, square foot, etc.). A dollar value is, then, ascribed to either the volume or area nomenclature (i.e., $0.25 per square foot for drywall installation) and that dollar value is multiplied by the quantity of estimated material (i.e., square footage of drywall) necessary to complete that portion of the project. This process would complete the calculation for the labor cost portion of the project.

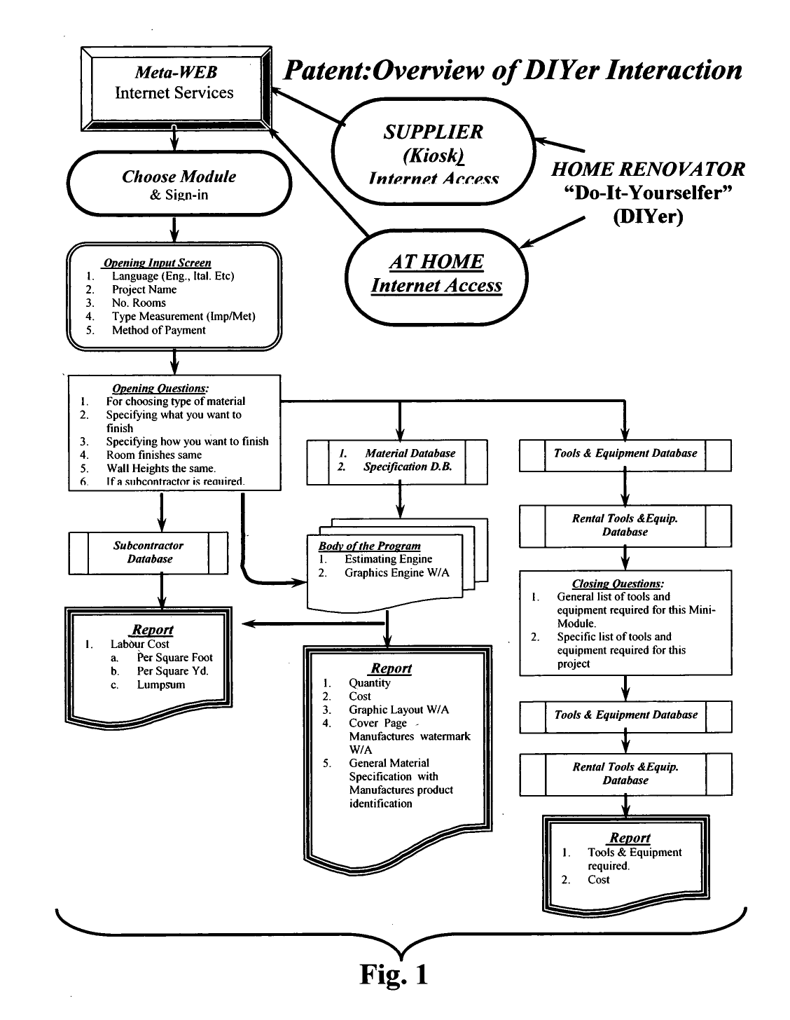

The aforementioned synopsis is an abbreviated and rudimentary profile of how a contractor (as opposed to a DIYer) derives an estimate. With this in mind, the estimation system according to the present invention makes available to the general public, in particular, the DIYer, measures to start and complete small projects at home or at a local supplier. The overall DIYer estimation system of the present invention is described, in general, at FIG. 1. With the estimation system, the DIYer acquires all information on quantity of material, cost of material, and tool and equipment requirements, their respective cost, and the cost of labor. To facilitate the DIYer project, a number of questions must, first, be answered:

1. Who pays for the use of the estimation system?

2. How does a DIYer gain access to the process?

3. How is the DIYer supplied with the required information for material quantity and cost?

4. How does the DIYer find out what tools to use?

5. How can the DIYer get a professional labor budget if the DIYer wants someone else to do the labor?

6. How does the DIYer find a competent contractor to do that labor if so desired?

The first question is answered by the method of doing business according to the present invention, which is described in more detail below.

The second question is answered by utilization of the Internet.

The third through sixth questions are answered by the construction estimation system according to the invention.

After considerable investigation, it was discovered that the most important factor is making sure that the process (i.e., software) is simple to use and that it is so simple that the DIYer only has to answer questions in order to acquire the information needed to complete a respective project.

The main consideration was taking a complex estimating system and making it into a simple question and answer estimating system. For example, to ascertain an exact square footage of all the elements in a single room that is to be painted, a contractor would use a procedure summarized in steps set forth in the following text. As will be shown, each step requires a certain amount of knowledge that is, typically, not known by a DIYer. As detailed in the subsequent sections, the estimation system of the present invention eliminates the requirement of advanced training by providing an expert system that supplies all information not required to be known by the DIYer. As such, when a contractor step is mentioned below, a corresponding parenthetical reference will be made to the relevant portion of the process of the estimation system, each reference being discussed later in a respective section herein. The illustrated example is the painting of a room. This example is only intended to be illustrative.

To estimate painting a room, for example, a contractor substantially performs each of the following steps:

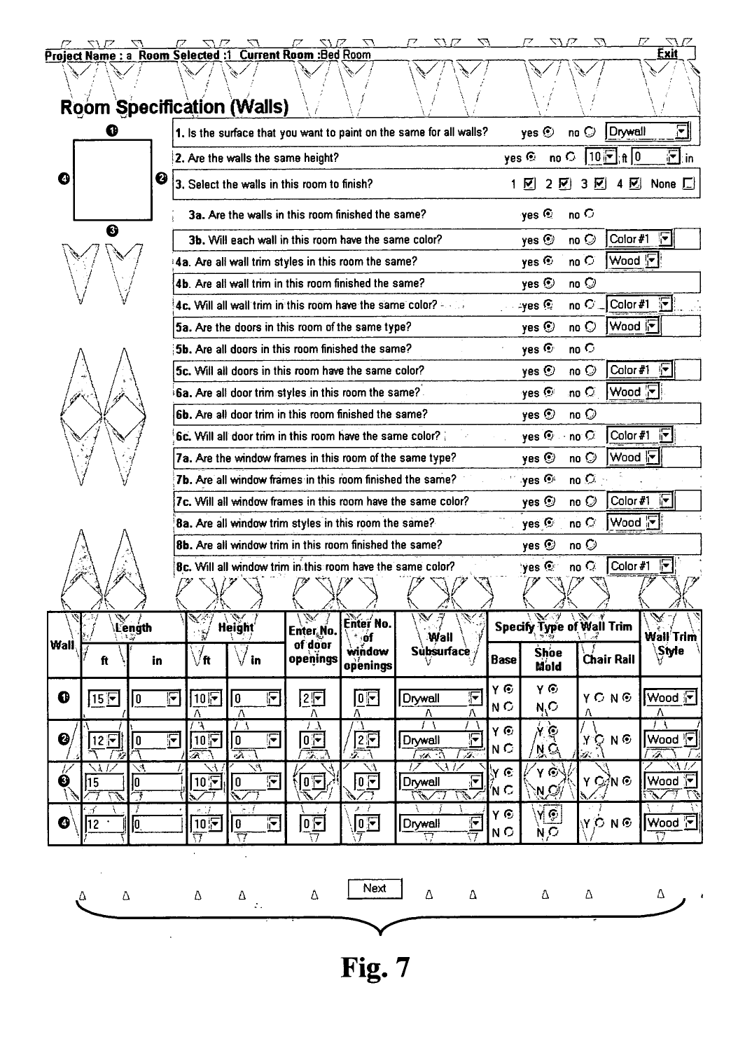

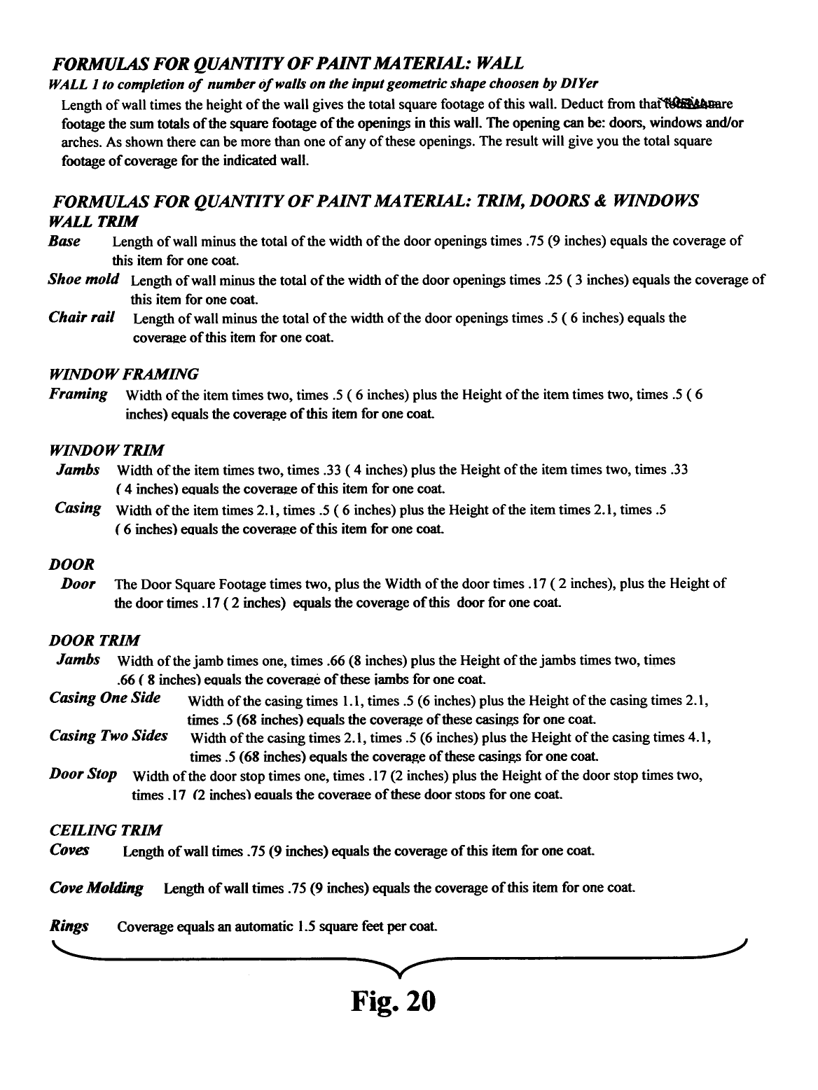

1. First, the length of one wall is multiplied by the height for that wall. The total of the multiplication equals a total square footage of a given wall. (See FIGS. 7 and 20). This step is repeated for each wall to be painted in the room.

2. The square footage of all walls are added together to produce an estimated total square footage of wall area in the room.

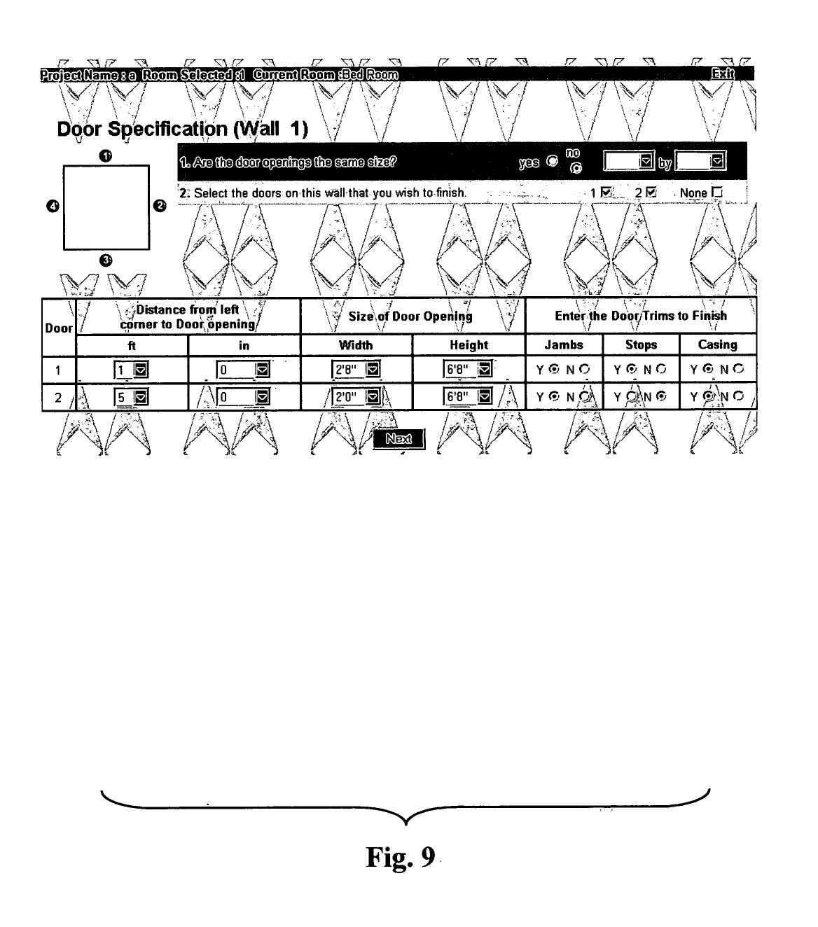

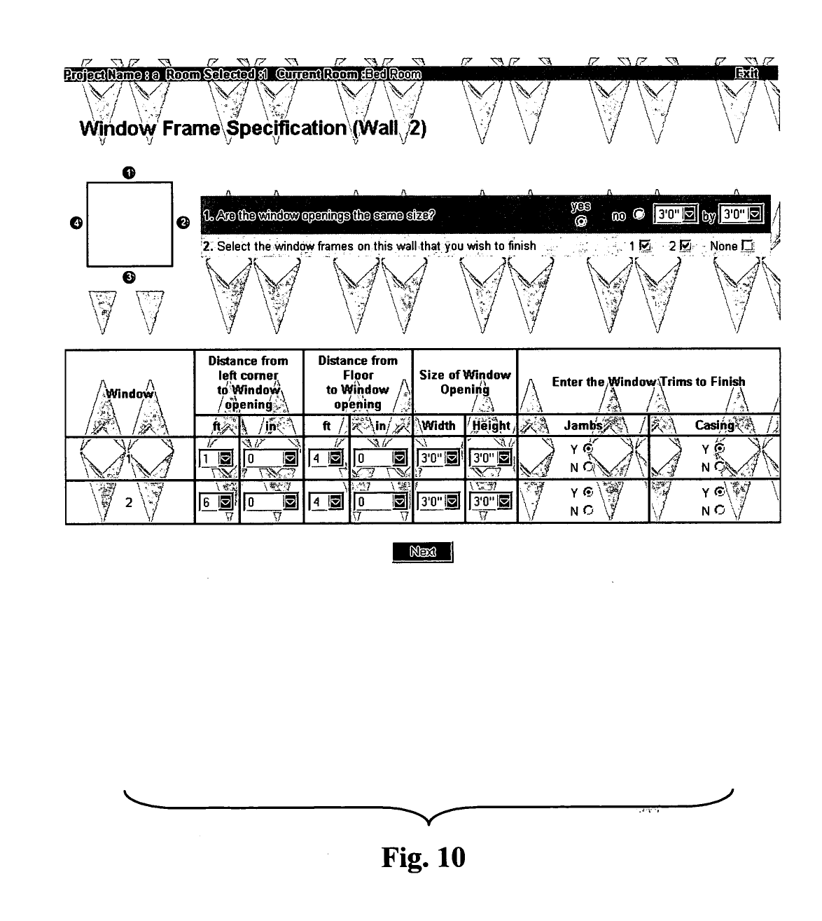

3. A height of each opening in the room (i.e. door, window, arch, etc.) is multiplied by a width of each opening to equal a square footage of each opening. (See FIGS. 9 and 10).

4. The square footage of all openings are added together to produce an actual total square footage of opening area in the room.

5. The actual total square footage of opening area is deducted from the estimated total square footage of wall area (step 2 above) to produce an actual total square footage of wall area to be painted.

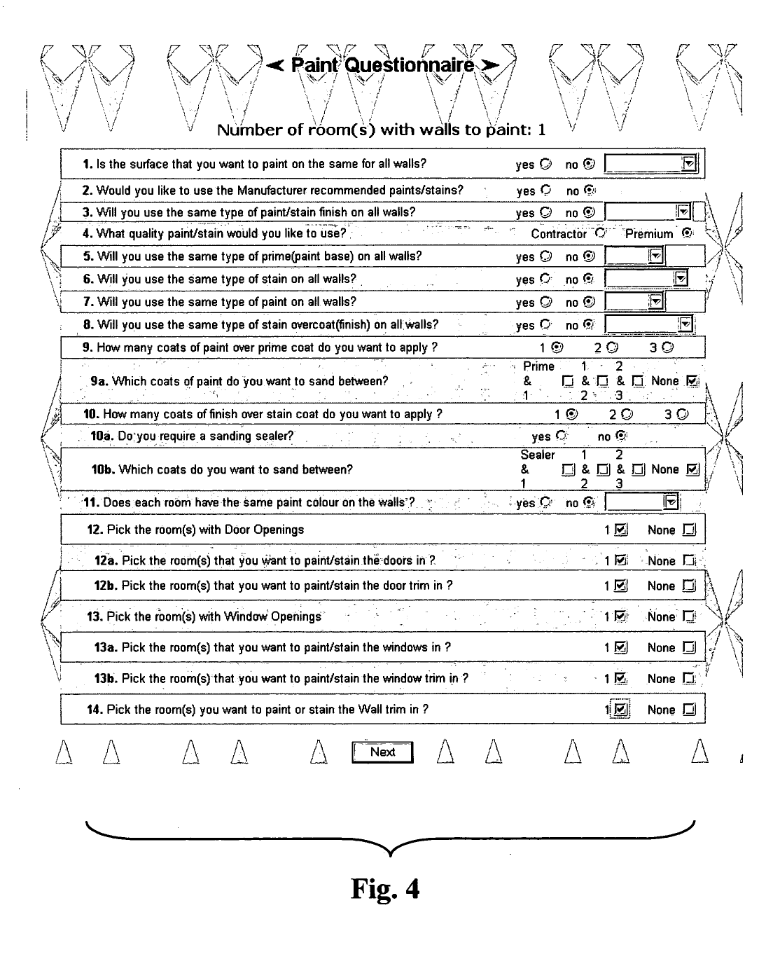

6. Now, a primer type is determined based upon the type of wall surface existing in the room (i.e., concrete, drywall, etc.) and, possibly based thereupon, a selection of an oil- or latex-based paint is made. (See FIG. 4, questions 1 and 5). To determine a gallon quantity of primer that is needed, first, the manufacturer's recommended amount of wall area coverage for each gallon of primer is checked (i.e., 1 gallon covers 300 square feet). The actual total square footage of wall area is divided by the manufacturer's coverage per gallon for the primer. The quotient gives a respective gallon quantity of primer required to complete the task.

7. Next, the option of scuff sanding before applying a finish coat(s) is queried (see FIG. 4, question 9a).

8. Then, the number of finish coats is determined and there is a query of whether or not there will be sanding in between coats. (See FIG. 4, question 9). When the number of finish coats is determined, the gallon quantity of finish paint that is required for each finish coat is determined by following the procedure for primer as in step 6 above. This gallon quantity per coat is, then, multiplied by the number of finish coats to obtain total gallon quantity of finish paint that is needed. It is noted that if the manufacturer's coverage amount for the finish paint and the primer is the same, then only one of these calculations need be made for each coat as the gallon requirements of paint and primer will be equal. In such a case, the single calculation is multiplied by the number of total coats, primer plus finish.

9. The quantity of sandpaper required to complete the project is also determined dependent upon the actual total square footage of wall area and the number of coats to be sanded.

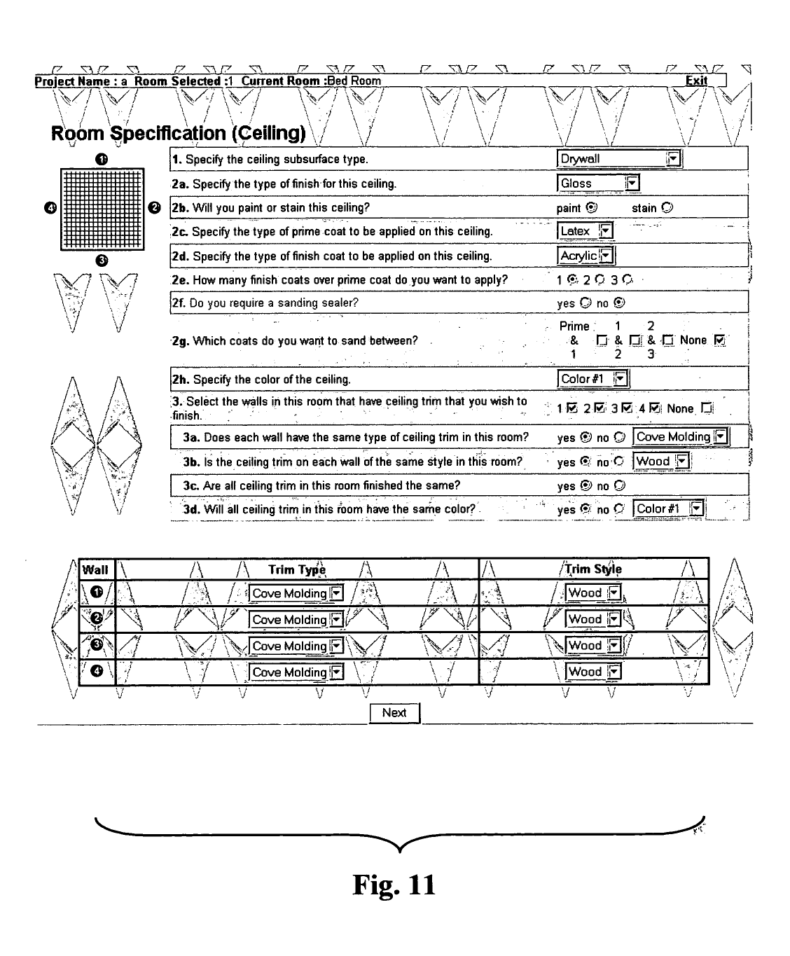

10. If the ceiling is to be painted, the same procedure as above is followed for estimating the quantity of paint material for the ceiling. The formula for the ceiling square footage is the length times the width of the ceiling area less any openings (skylights, etc.). See FIGS. 11, 15, and 16.

11. Other material estimates to be considered with regard to painting the room include windows, doors, casing, base molding, shoe molding, etc. (see FIG. 20).

12. Finally, a contractor would also have to estimate the labor cost for this job, which is performed, for example, by multiplying the square footage of the entire project by the number of coats to be painted (primer plus finish). For example, if the actual total square footage of wall area is 1000 square feet, and the painter's labor price is $0.10 per square feet per coat, and two finish coats plus one primer coat is required, then the painter's labor price will be $0.10*3*1000=$300.00. As for other elements of the room, i.e., doors and trim, labor is priced per door and trim is charged per linear foot.

The preceding simplified example is a small sample of what has to be considered for a proper estimate to be completed and provides a “taste” of the complexity.

Based upon this complicated estimation procedure, the estimation system of the present invention was created. The estimation system represents a dramatic departure from the normal way an estimate is completed so that the DIYer can receive accurate information in a timely manner. What is not preferable is for the DIYer to wrestle with the complex formulas in order to find out what was needed to complete the job.

The preferred vehicle for providing the DIYer with estimating programs is the Internet. (See FIG. 1) This is true for a few reasons. First, the Internet is being used more and more by consumers to gain access to the cost of products and services. Second, the Internet provides the needed level of security required to protect the process. Third, the DIYer has twenty-four hour access.

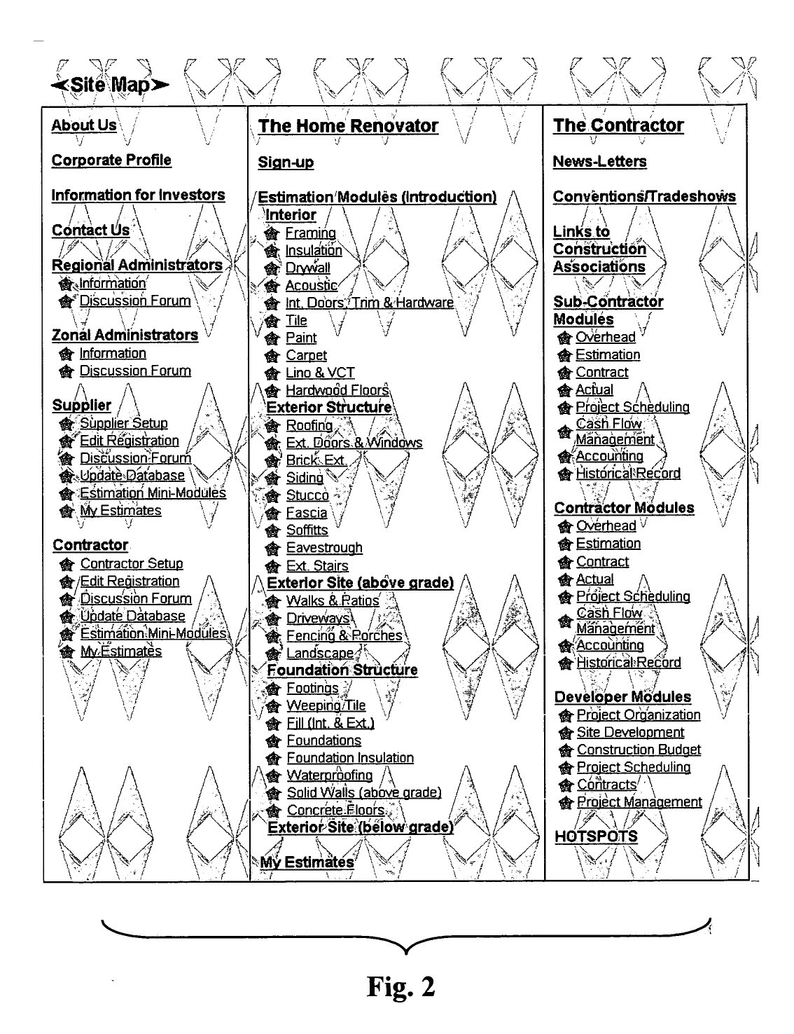

The following text is a detailed description of one module of the estimation system of the present invention. This module, referred to as the painting module and found as one of the mini-modules illustrated in FIG. 2, derives answers to the questions of material quantities and cost, tool and equipment requirements, and labor budgets. Other modules, such as drywall and insulation (see also FIG. 2), are configured to function much like the paint module, etc.) with the added feature of giving the DIYer a graphic layout that will permit the DIYer to put up the material by “literally following the numbers.” As shown in FIG. 2, the estimation system of the present invention contains at least thirty-six modules, each of which applying the same query based structure described below. The differences between the modules are only the questions that are asked and the corresponding relevant information provided in the respective databases. All filtering systems, estimating engines, costing databases, and reports, preferably, remain as a constant from the perspective of a DIYer when using the system for his/her home renovation project. Thus, the description is not repeated for each of the thirty-six modules. Of course, a system administrator can improve, revise, update, etc. the system as needed.

### Initial Use of the Estimation System

Because the estimation system is, preferably, used by the DIYer 1 over the Internet, access of the system can be accomplished through any computer terminal connected thereto, whether through a phone line, DSL, a cable, or satellite. A preferred computer configuration for using the estimation system, whether from a residence 10 or a commercial location 20, such as a supplier kiosk, is a computer system (for example, with a minimum configuration of (CPU) Pentium 4, 1.6 GHz, 128 RAM, 60 GB Hard Drive with a keyboard, mouse, monitor (15″-17″, 800×600, 65K Colors), laser printer, and the Internet connection). See FIG. 1. Although this is a preferred configuration, it is not mandatory. Because ease of use is an important quality, also preferred is a system that employs “point-and-click” selection whenever possible.

To gain access, a user (the DIYer) enters the provided Internet services website 30 and is presented with the various module choices 40 as shown in FIG. 2. The user is taken to the opening input screens 50 (see also FIG. 2) where he/she signs in and chooses the relevant module to use for the project. Once a new user clicks on a “Sign-up” feature (see middle column of FIG. 2), an introductory page gives the user instructions whether they want to continue using the system “at home,” which incurs a cost to the DIYer, or they would like to complete their estimates at a supplier selected by the user later and who will provide the necessary materials to be used at reduced cost for the usage. Selecting a supplier passes the cost of using the system onto the supplier. Once the user has made this choice, the user will enter a zip/postal code (for selecting a nearby supplier, if any) and will pick the appropriate module to be used (i.e., drywall, insulation, paint, framing, trim, tile, carpet, etc.). See FIG. 2. If the user is at home, then entry of a credit card number is necessary to continue with the estimate that will be provided. Alternatively, if the user is at a supplier kiosk (and, therefore, has that supplier's access code) then, the supplier will be billed for the DIYer's use of the system and the user can continue with the estimate. The DIYer can be asked to register relevant data (i.e., name, address) for the supplier's use. In such usage, the supplier can provide a discount to the DIYer if the DIYer buys the recommended materials or supplies from that supplier.

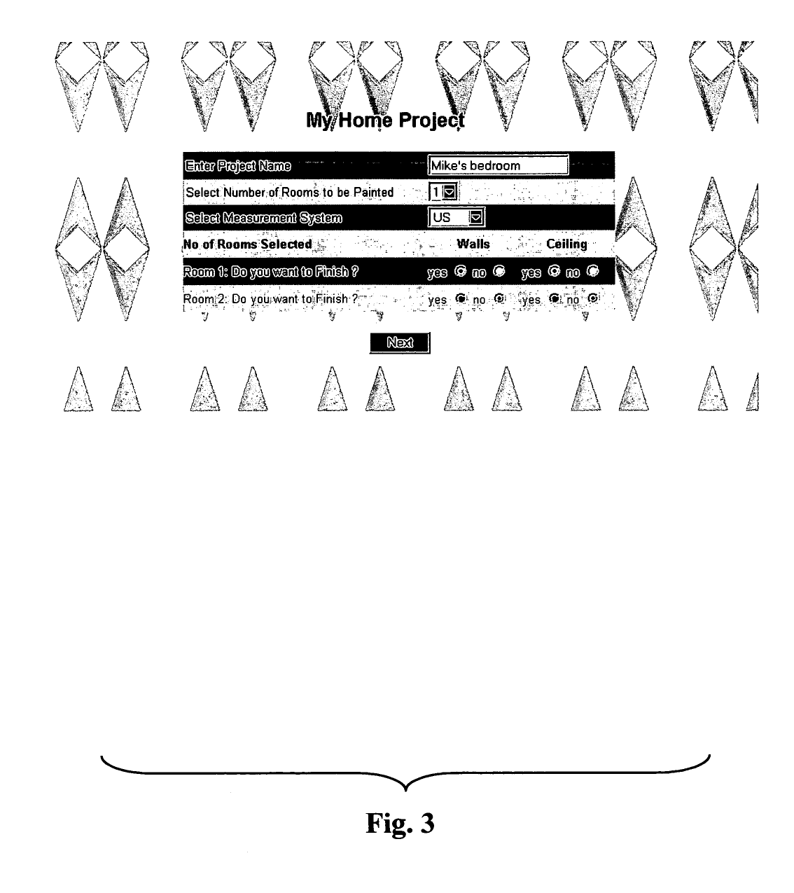

The user selects the relevant module 60. The following example uses one of the modules, the paint module, to explain how each of the modules work. The user is taken to the initiation phase, in other words, the “My Home Project” worksheet illustrated in FIG. 3. The DIYer enters the project name, selects a number of rooms to be painted (assuming the paint module was pre-selected), selects a measurement system (metric or US), and chooses whether the walls and ceilings in the room(s) will be finished.

All questions are structured for “point-and-click” format with a computer mouse to save the DIYer from the effort of inputting information manually. The questions put to the DIYer follow a logical format that leads the DIYer through to an effective conclusion for finishing a respective project. The initial entries start the process that enables the DIYer to obtain the estimates for material quantities, material cost, tool requirements and cost, equipment requirements and cost and the contractor labor cost with a list of local skilled contractors. The DIYer can also receive a graphic layout material installation design in certain modules . Two examples of the installation design produced by the system can be found below, a first of the examples being a Batt insulation installation and the second being a drywall installation. See also Drywall 1.0, “A software package for Optional Drywall Installation,” Sep. 17, 1996, R. Caron, C. DiGiacomo, T. Braithwaite & K. Roy). The following text illustrates the procedure for a project utilizing the paint module.

### Module Query Sub-System

The query system begins the initial quest for the answers that the DIYers require to successfully complete each module-specific portion of a project. For example, in the paint module, various questions are structured so that the DIYer can do a wall portion of the project from a simplest level to a more complex and customized level. The following text describes how the DIYer would estimate materials and labor for a painting job using the paint module of the present invention.

In the simplest level, the DIYer only paints the wall(s) one color using a prime coat (see FIG. 4 at question 5) and a finish coat (see FIG. 4 at question 6) without taking into consideration any existing openings. This type of estimate is the most rudimentary and the DIYer can complete this task and receive results in less than five minutes.

However, if the DIYer would prefer to do a more exact estimate, including, possibly, a different color paint/stain on each wall, then the DIYer would follow the entire questionnaire of the paint module and answer all relevant questions. Each question that is asked will be used to “instruct” the underlying databases to what the DIYer wants to do.

Following FIGS. 3 to 12, the “Paint Wall Questionnaire” of FIG. 4 is filled out first. A description of each question therein is set forth in the following text.

Question 1 will instruct the database as to the type of paint and/or stain that is required to do the project and whether or not the paint and/or stain is the same type on each wall.

Question 2 allows the DIYer to select their own paint or to choose one that is recommended by a manufacturer and, therefore, receive certain quality assurances, guarantees, and/or warranties. The selection to this question will direct the system to access the database having manufacturer specifications and list them for the DIYer.

Question 3 will be used by the relevant database for measuring the amount of paint/stain required for the walls.

Question 4 will be used by the relevant database to provide appropriate costs for the material to be used.

Question 5 will be used by the relevant databases for amount and type of prime coat.

Question 6 will be used by the relevant databases for amount and type of stain coat.

Question 7 will be used by the relevant databases for amount and type of finish coat.

Question 8 will be used by the relevant databases for amount and type of stain overcoat.

Question 9 will be used by the relevant databases to decide the quantity of prime coat that is required.

Question 9a will be used by the relevant databases to decide the amount of sandpaper that the DIYer will require.

Question 10 will be used by the relevant databases to decide the quantity of finish coat over the stain that the DIYer will require.

Question 10a will be used by the relevant databases to determine the quantity of sanding sealer that the DIYer will require.

Question 10b will be used by the relevant databases to determine the amount of steel wool that the DIYer will require.

Question 11 will be used by the relevant databases to determine the quantity of material for each color required.

Question 12 will be used by the relevant databases to further determine the quantity of material by deducting the area that the door opening takes up from the overall surface area and signifies that there is/are door(s) in the room(s).

Question 12a will be used by the relevant databases to determine that the DIYer wants to finish the doors and will assist in the determination of the quantity of material required if the DIYer wants to paint/stain the doors.

Question 12b will be used by the relevant databases to determine if the DIYer wants to finish the door trim and will assist in the determination of the quantity of material required if the DIYer wants to paint/stain the door trim.

Question 13 will be used by the relevant databases to determine the quantity of material by deducting the area that the window opening takes up from the overall surface area and signifies that there is/are window(s) in the room(s).

Question 13a will be used by the relevant databases to determine that the DIYer wants to finish the windows and will assist in the determination of the quantity of material required if the DIYer wants to paint/stain the doors.

Question 13b will be used by the relevant databases to determine that the DIYer wants to finish the window trim and will assist in the determination of the quantity of material required if the DIYer wants to paint/stain the window trim.

Question 14 will be used by the relevant databases to signify to the DIYer that there is wall trim (i.e., Chair rail) and to ask the DIYer if he/she wants to finish the wall trim, and, if so, to allow the DIYer to determine the quantity of material needed.

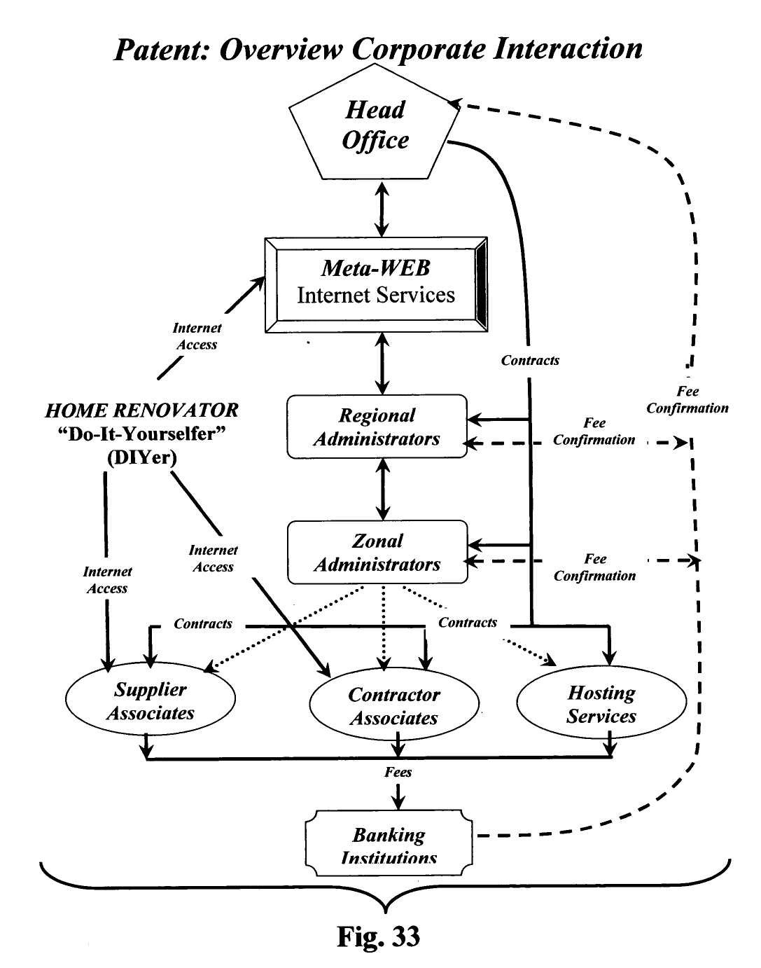

In summary, the questions that are answered with regard to FIG. 4 either determine that the DIYer has to go no further with his estimate or the answers will take the DIYer to another level to complete the estimating of the DIYer's requirements. The way in which the questions are answered in the paint module will also automatically trigger use of the databases for tools and equipment (see FIG. 29). These databases list the tools required based upon the materials that are being used by the DIYer. By completing the questionnaires according to the present invention, a list of the requisite tools is made to the DIYer for the DIYers approval.

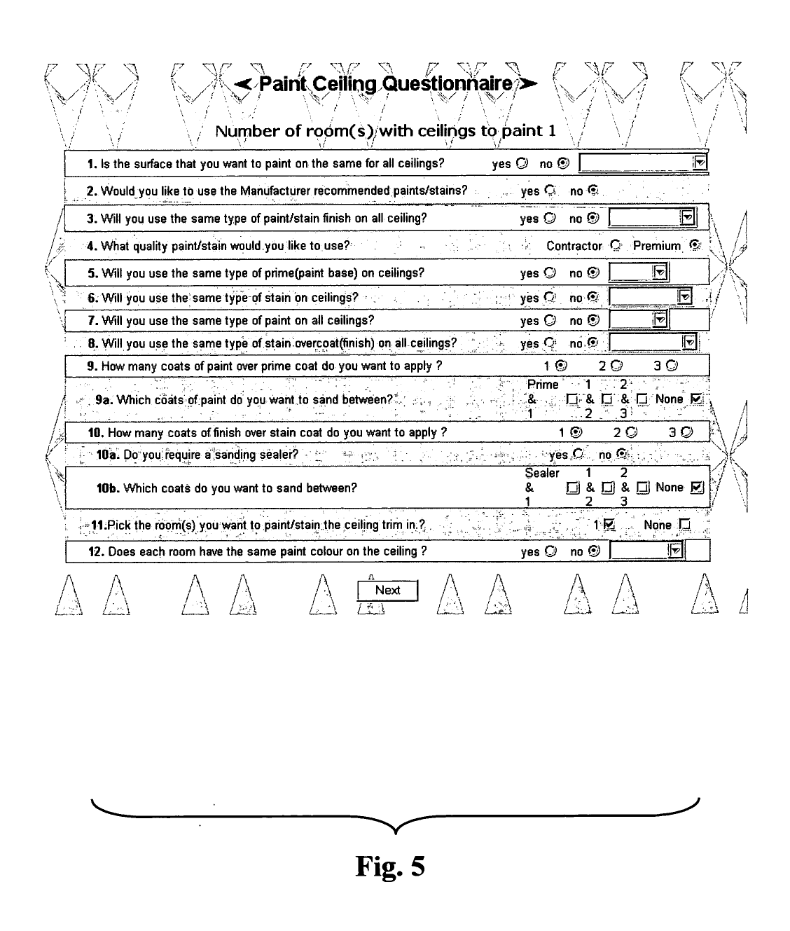

After the wall questionnaire is completed, the DIYer is directed to the “Paint Ceiling Questionnaire,” which is illustrated in FIG. 5. The Paint Ceiling questionnaire is an extension of the Paint Wall Questionnaire of FIG. 4 and deals with the ceiling(s) in the room(s) to be painted. Similar questions are asked with the same determinations being made for quantity, quality etc.

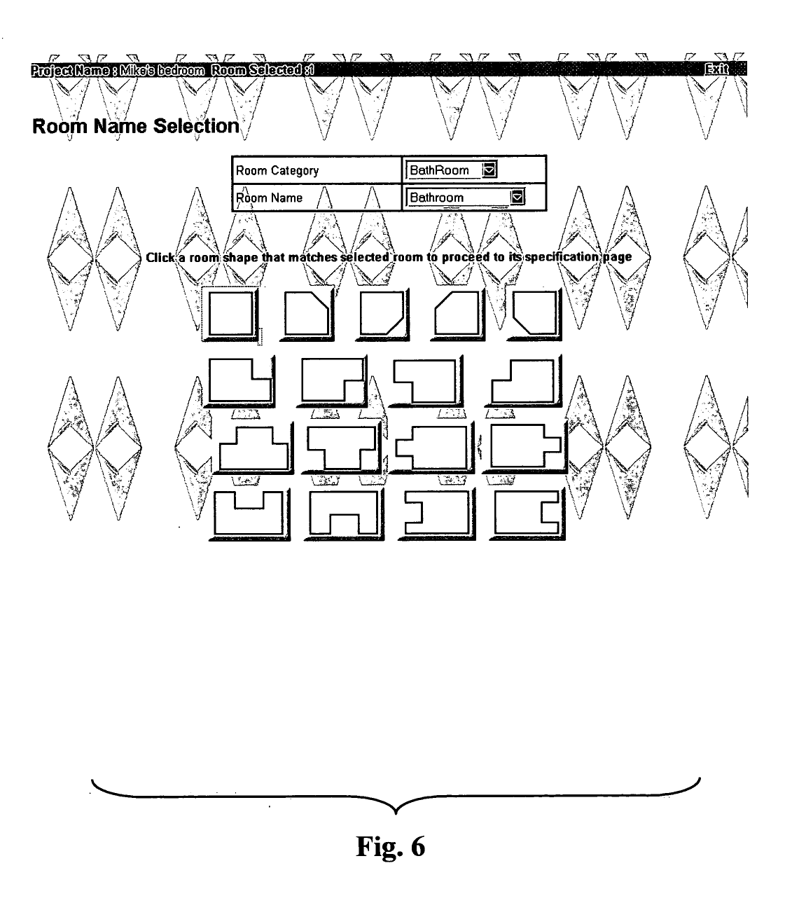

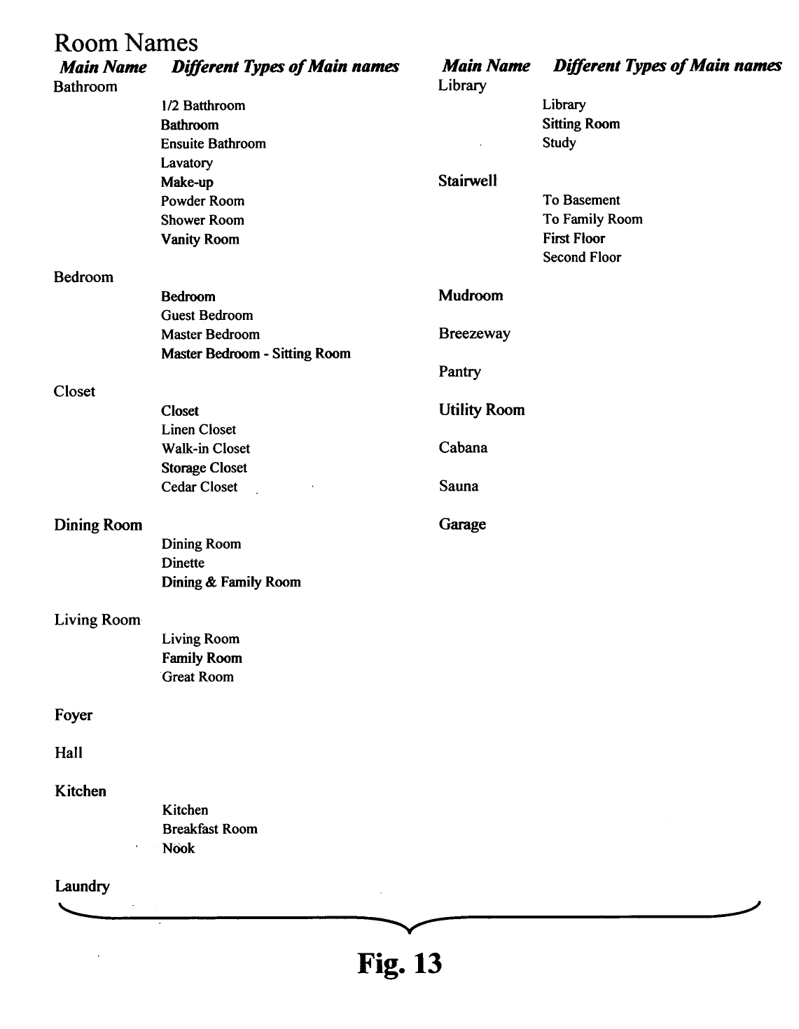

The DIYer is, then, asked to complete the “Room Name Selection” worksheet illustrated in FIG. 6. Here, the DIYer selects the “Room Category” and the “Room Name” drop down boxes, which are connected to a Room Category and Name database illustrated in FIG. 13. The Room Category can be a more general description, i.e., a bathroom, while the Room Name can be a more specific description, such as a type of bathroom, i.e., ½ bath, on suite, master bathroom.

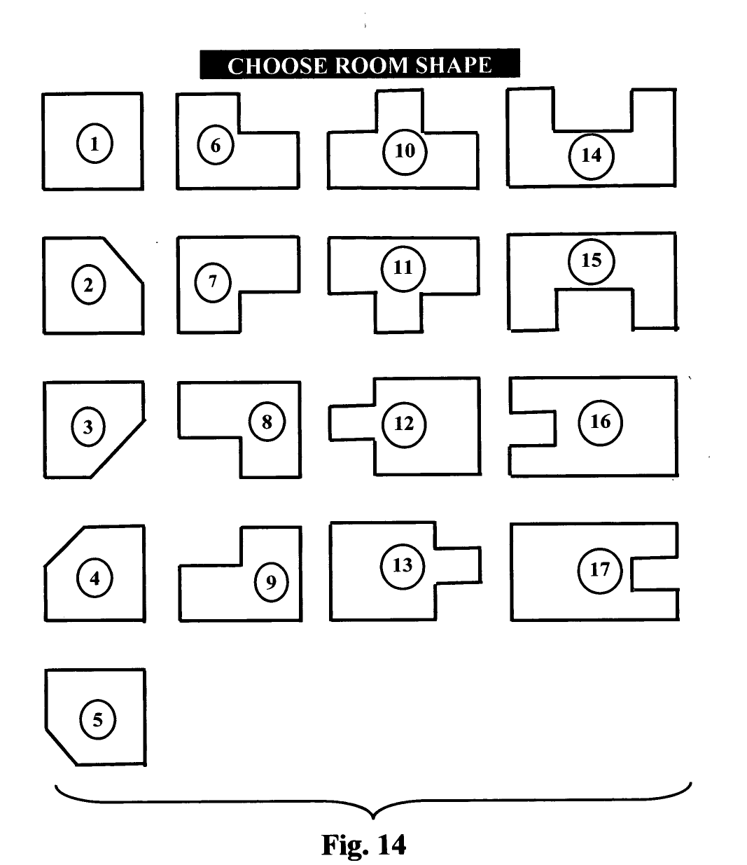

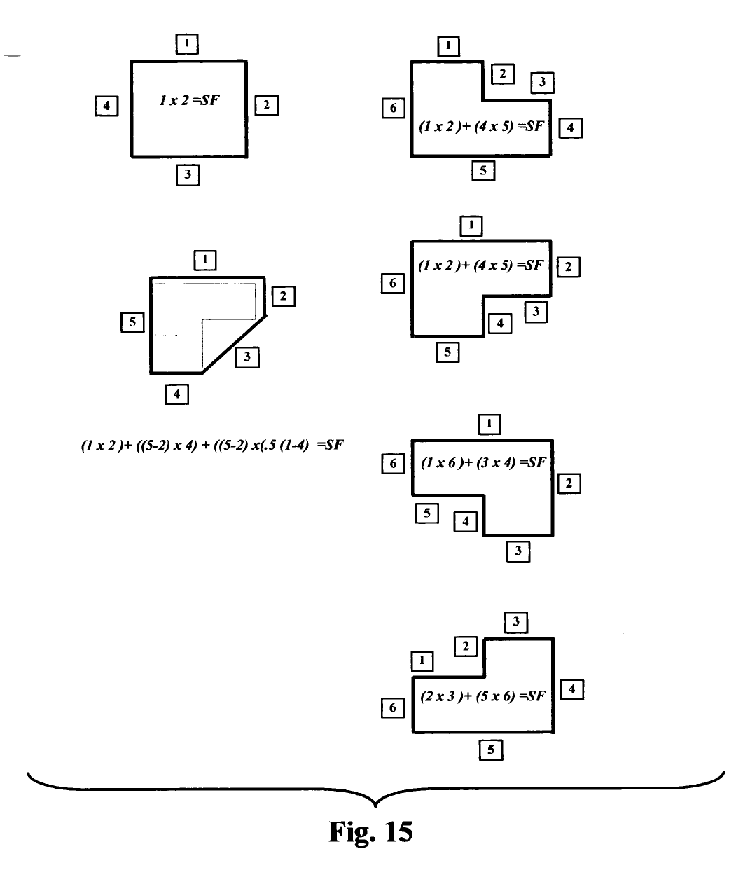

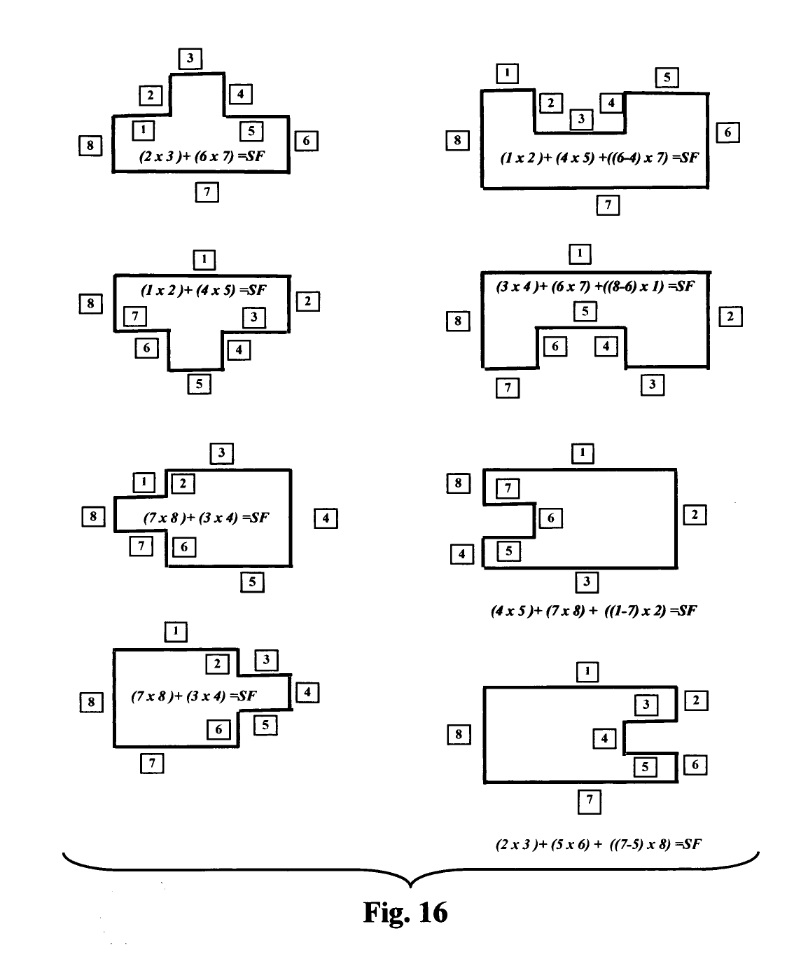

Also associated with the Room Name Selection are Room Shape Buttons, examples of which may be found in the bottom of FIG. 6. To indicate to the system the kind of room that is to be painted, the DIYer selects, for each room, one of the Room Shape Buttons that most closely resembles the shape of the room that the DIYer is going to renovate. See also FIG. 14. Once a Room Shape Button is depressed it will provide the program with the number of walls present in the room to be renovated. This action launches the DIYer into the “Room Specification” worksheet, illustrated in FIG. 7, where the DIYer is instructed to answer another series of questions and to input specific measurement data. With the simple depression of the proper room shape button the DIYer launches the area-estimating portion of the system. The ceiling area is calculated by a series of formulas illustrated, for example, at FIG. 15 and 16, and the dimensions input in the worksheet of FIG. 7, which contains a series of drop down boxes in which the DIYer indicates the length and height of the wall.

The following text describes the question-and-answers relating to the Room Specifications (Walls) worksheet of FIG. 7. The box at the upper left corner of FIG. 7 is a room shape graphic illustrating the number of walls corresponding to the input dropdown boxes at the bottom of FIG. 7. The graphic corresponds to the room shape that the DIYer selected in the Room Name Selection worksheet of FIG. 6. Answers to various questions in FIG. 7 further define exactly what the DIYer wants to complete and if they want to finish different walls in different finishes.

Question 1 will permit the DIYer to specify if the surfaces that are going to be painted are made up of different finishes, i.e., some may be metal while others are drywall. This determination will affect the type of paint required and the information provided thereby will instruct the database on what paint materials are to be chosen. By choosing the specific type of surface, the invention will specify the type of paint (chemical make-up) that is required for that surface by the manufacturer and it will filter out that requirement from the particular database for the DIYer's use.

Question 2 informs the system if all wall heights are the same.

Question 3, 3a, and 3b inform the system if the walls are to be finished differently.

Question 4 responds to the DIYer instructing the system that he/she wants to complete wall trims and whether the trim on each wall will be completed the same or separately.

Question 5a to 5c responds to the DIYer instructing the system that he/she wants to complete doors and whether each door will be completed the same or separately.

Question 6a to 6c responds to the DIYer instructing the system that he/she wants to complete door trim and whether the trim on each door will be completed the same or separately.

Question 7a to 7c responds to the DIYer instructing the system that he/she wants to complete windows and whether each window will be completed the same or separately.

Question 8a to 8c responds to the DIYer instructing the system that he/she wants to complete window trim and whether the trim on each window will be completed the same or separately.

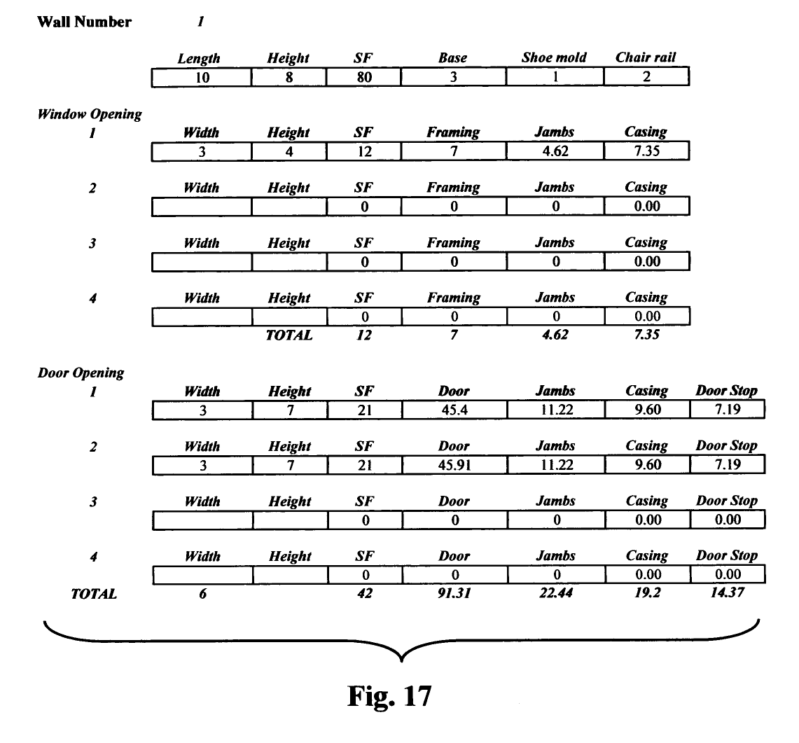

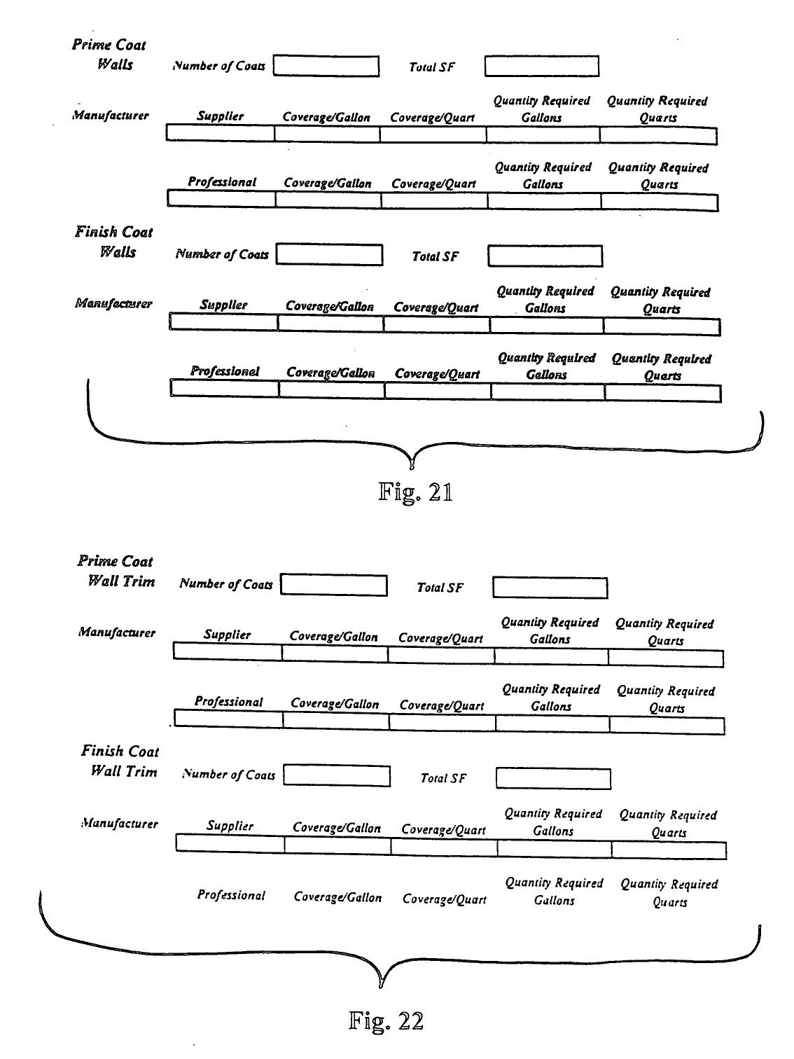

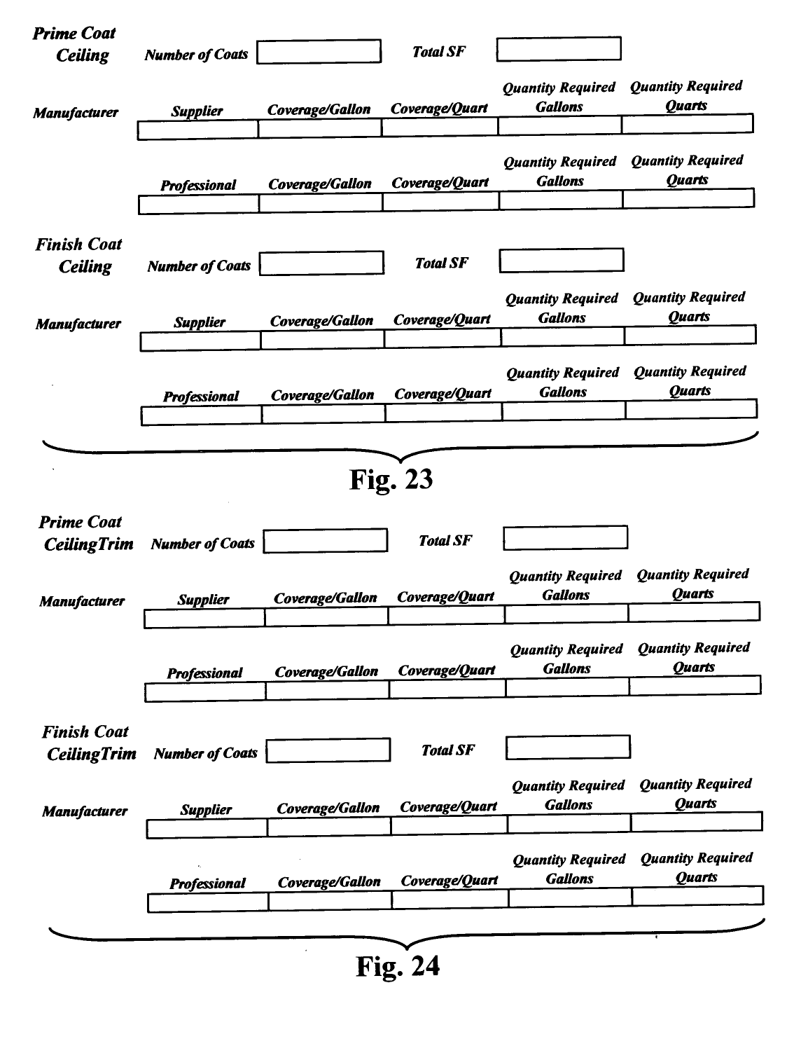

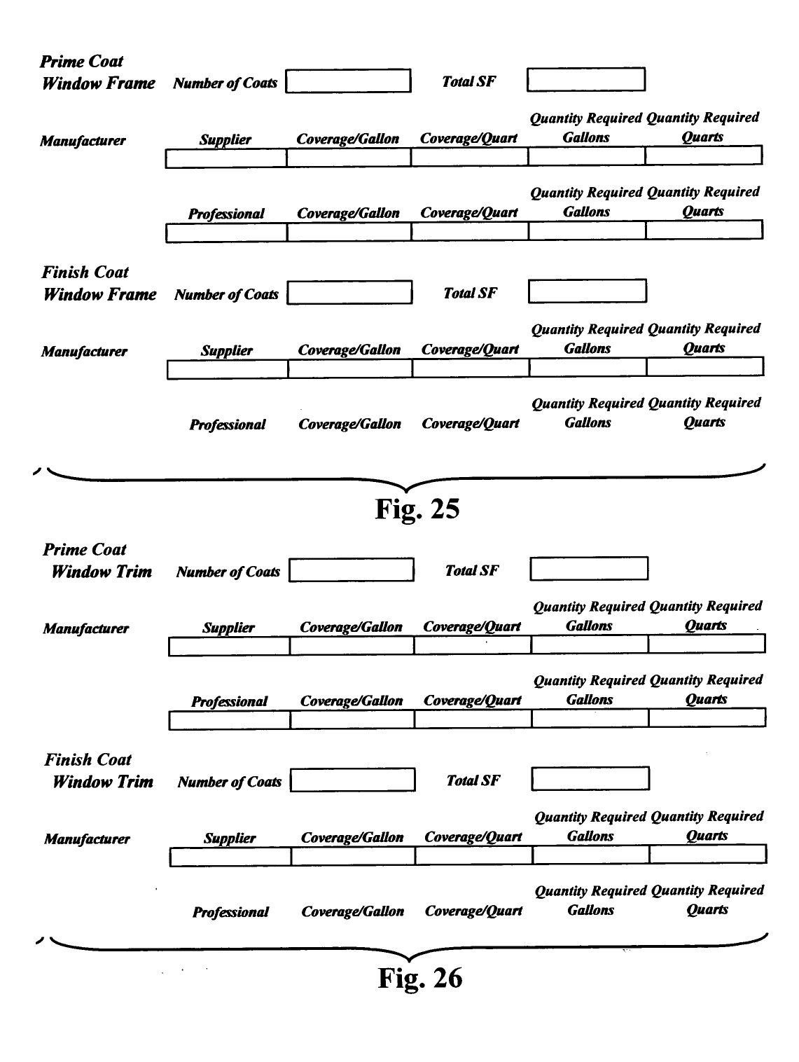

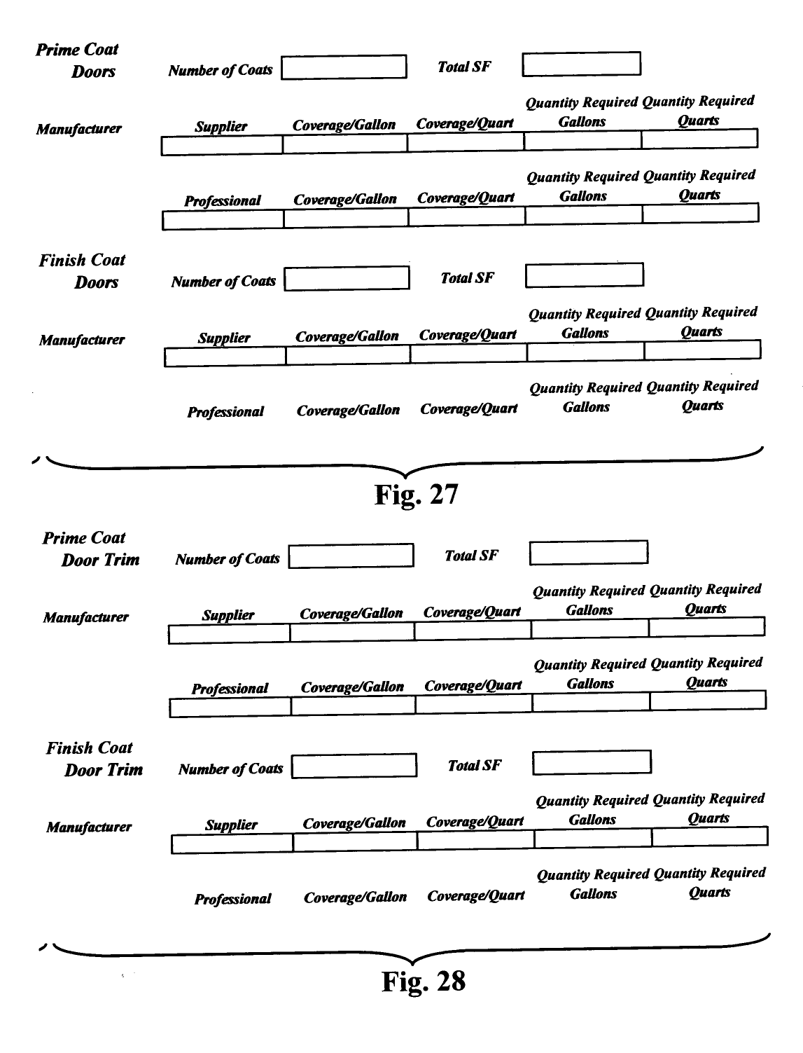

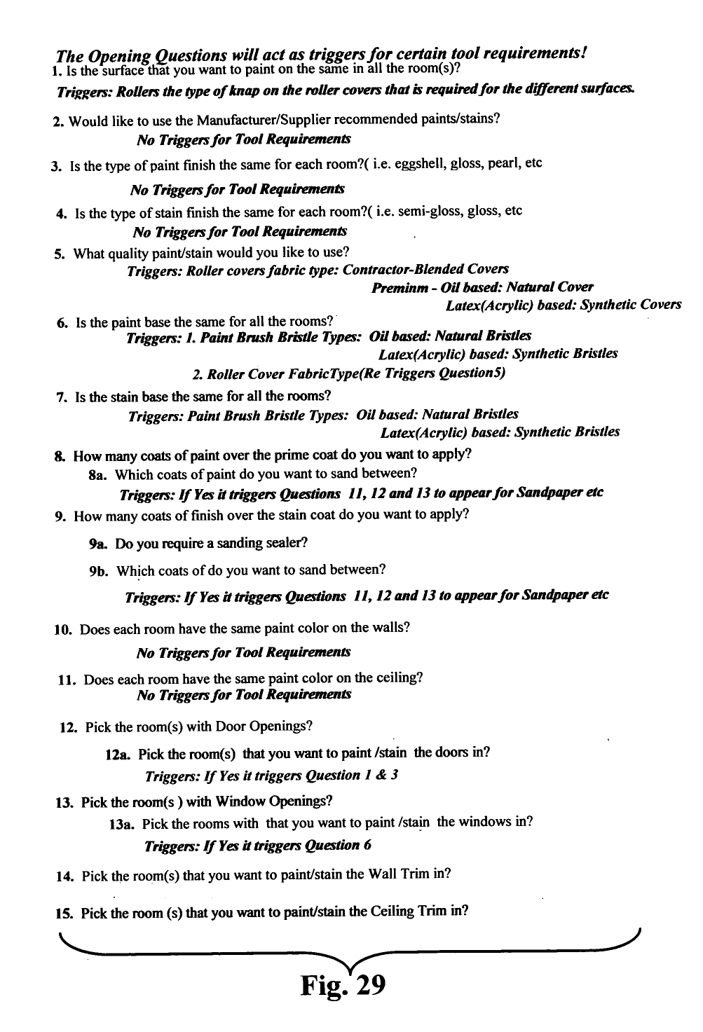

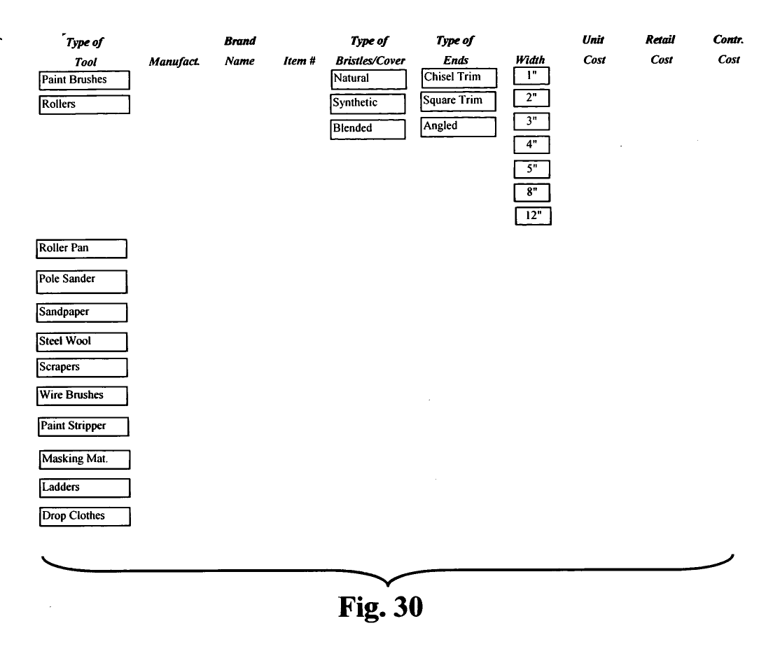

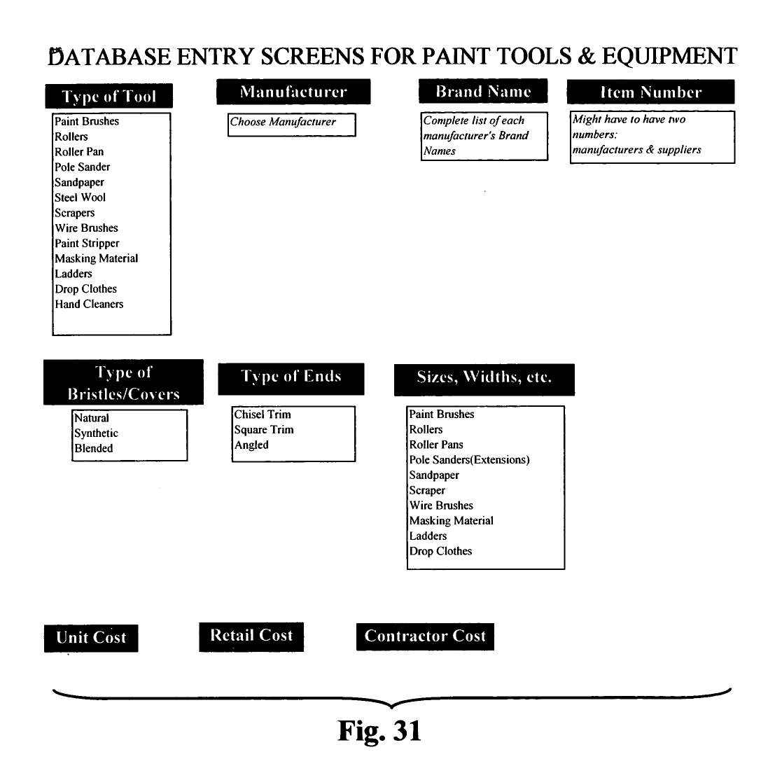

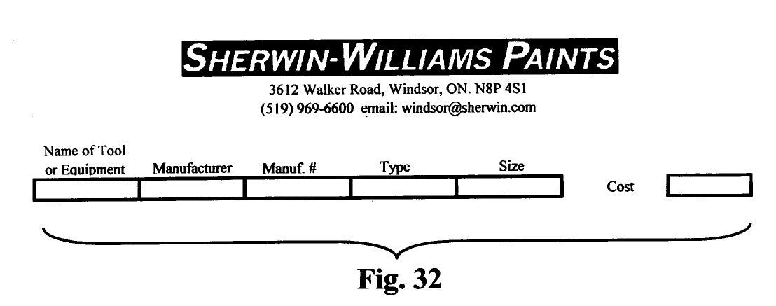

Each of the questions is programmed to interface with respective mathematical formulas able to ascertain the total linear footage, area, volume, etc. necessary to estimate the materials, tools, equipment, and labor required by the DIYer. Examples for such estimations may be found in the illustrations of FIGS. 17 to 28.

The input screens at the bottom of FIG. 7 are where the DIYer inputs the wall dimensions of a one room project and all other relevant information as required as per the DIYer's choices. As the DIYer inputs the individual wall dimensions, the wall that is currently being selected is identified in the Room Shape graphic by a highlighting feature. This information is processed by a graphic estimating engine (see Drywall 1.0, “A software package for Optional Drywall Installation,” Sep. 17, 1996, R. Caron, C. DiGiacomo, T. Braithwaite & K. Roy) and/or a numeric estimating engine (see information for numeric estimating engine in FIG. 17 to 19 and 21 to 28) for the quantities, linear footages, square footages etc. that are necessary to give an accurate estimate and cost of the materials that the DIYer will be using.

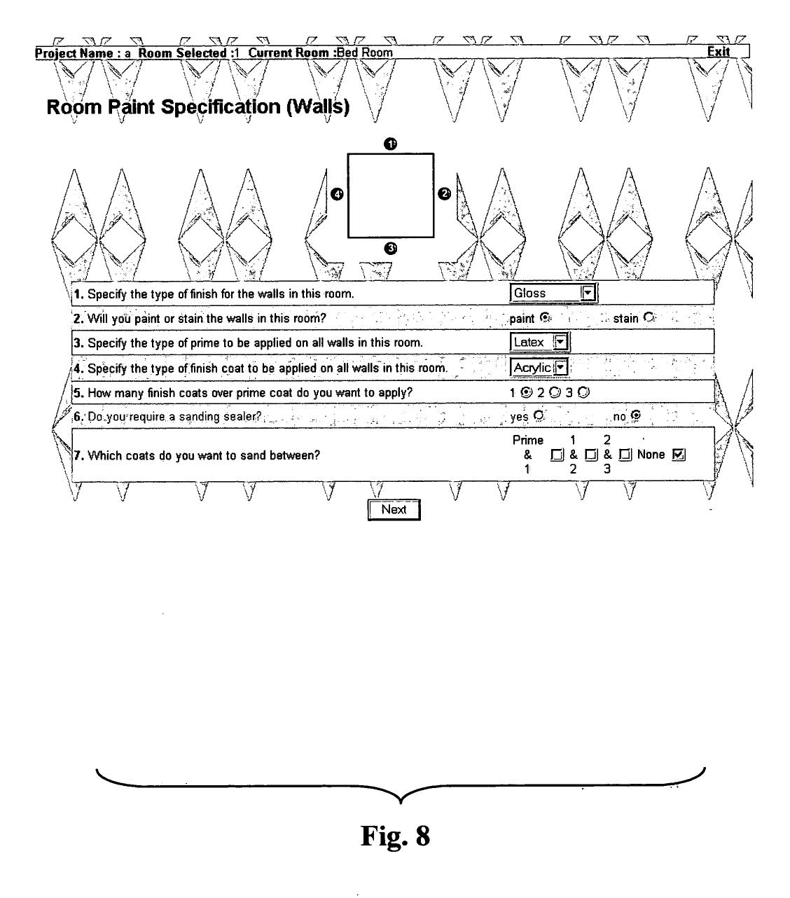

The DIYer is then directed to the “Room Paint Specification (Walls)” worksheet illustrated in FIG. 8. This worksheet further refines the query system so the DIYer can complete each individual wall in a separate customized shape. This refinement gives the DIYer the ability to finish each wall in a room separately, the shape previously being selected by the answers already given by the DIYer on the questions in FIG. 7.

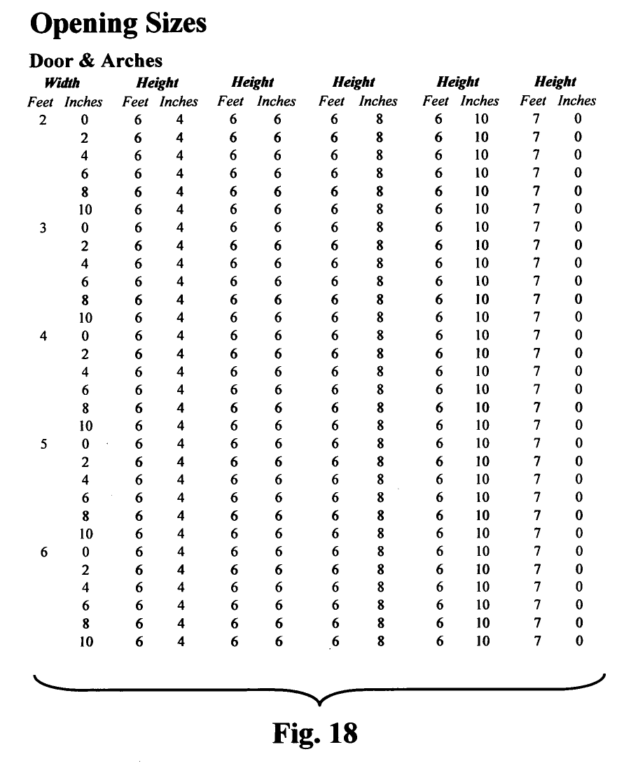

The “Door Specification” worksheet is illustrated in FIG. 9. This worksheet includes the graphical diagram of the Room Shape that was chosen already by the DIYer. This worksheet also has a query sub-system to be used by the DIYer for ascertaining exactly what the DIYer would like to do with the doors, specifically, with regard to painting/staining. A sample database used in conjunction with the Door Specification worksheet is illustrated in FIG. 18. Input boxes reside in the lower part of FIG. 9 and indicate where the doors are located on the wall of the room being considered by the DIYer. Sizes of door openings are connected with the database in FIG. 18 through the drop down boxes. At this juncture, the DIYer can signify the type of doors, whether or not the jambs, stops, and/or casings are to be finished, and the style of trim.

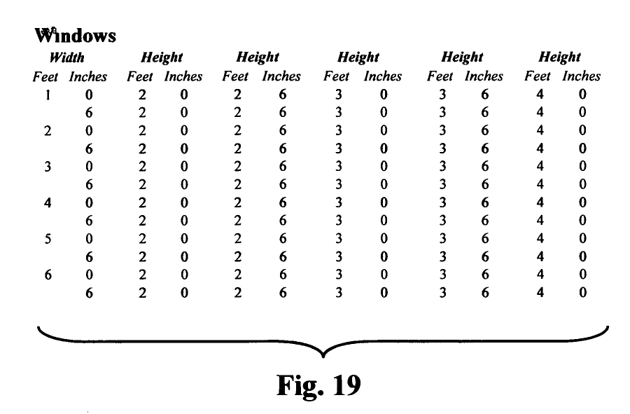

The “Window Specification” worksheet is illustrated in FIG. 10. This worksheet also includes the graphical diagram of the Room Shape that was chosen already by the DIYer. This worksheet similarly has a query sub-system to be used by the DIYer for ascertaining exactly what the DIYer would like to do with the windows, specifically, with regard to painting/staining. A sample database used in conjunction with the Window Specification worksheet is illustrated in FIG. 19. Input boxes reside in the lower part of FIG. 10 and indicate where the windows are located on the wall of the room that is being considered by the DIYer. Sizes of window openings are connected with the database of FIG. 19 through the drop down boxes. At this juncture, the DIYer can signify the type of windows, whether or not the window frame jambs and casings are to be finished, and the style of trim.

The “Room Specification Ceiling” is illustrated in FIG. 11. This worksheet also includes the graphical diagram of the Room Shape that was chosen already by the DIYer. This worksheet, likewise, has a query sub-system to be used by the DIYer for ascertaining exactly what the DIYer would like to do with the ceiling, specifically, with regard to painting/staining, and any trim the DIYer would like to finish. As with the previous questions, each question interacts with the corresponding databases to produce further questions in refining what the DIYer wants to accomplish for finishes and all of the estimating information and costs to accomplish that end. Input boxes reside in the lower part of FIG. 11 so that the DIYer can input the ceiling dimensions to enable the estimating databases, see, i.e., FIG. 15, to estimate any quantities of materials, equipment, and/or labor that are required. The DIYer can also choose to paint the ceiling trim at on each wall if he/she so chooses.

There are other relevant areas, but, for the sake of simplicity, they are not being shown or described herein because they are redundant in performing the continual precise measurements of quantities through the query system of other areas of completion, i.e., window frame, trim, door jambs, etc. They access the databases through the same interaction as shown previously. The interaction that is used through the query system and database filtering mechanisms can be used to filter any information required from the databases that has been set in place for the purpose of obtaining specific estimating information for quantities, tools, equipment, labor amounts and costs.

The above text has explained how one specific process of the method and system of the invention can be performed. Each larger area of the specifications uses the same Q & A system to query the relevant database for information that is specific for those specifications. Reference is made to FIG. 9 and to FIG. 10 for some further examples of the Q & A database interfaces.

### Checklist and Equipment

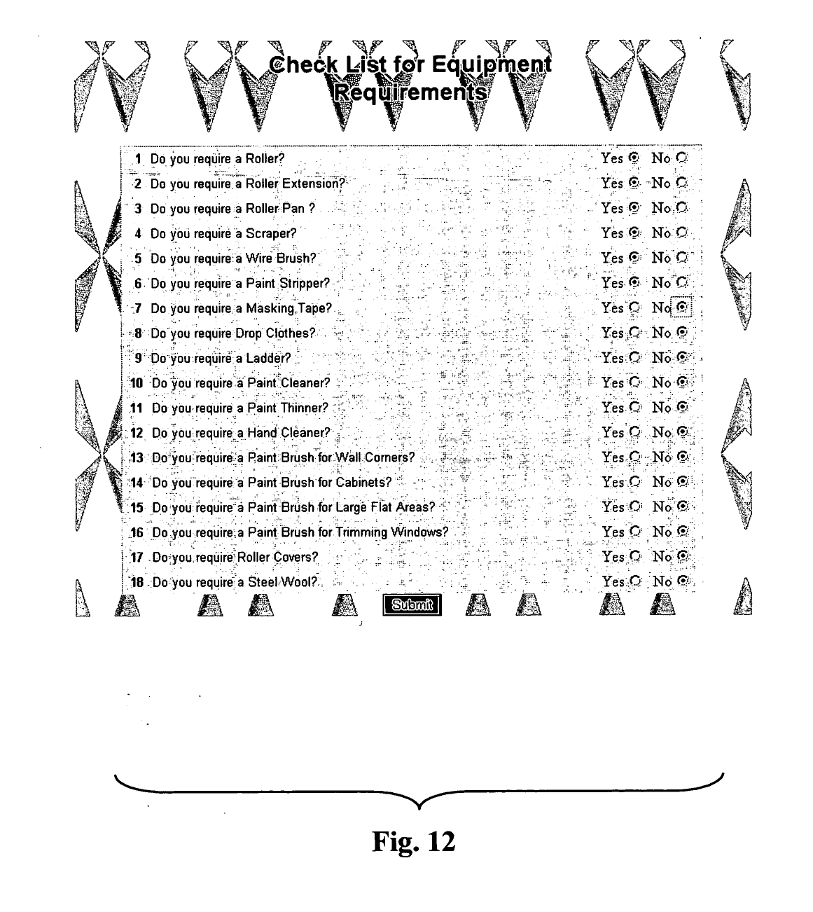

After completion of all estimating information by the DIYer, the final checklist query system for tools and equipment that the DIYer will require is to be completed. All of the queries will be answered either “Yes” or “No”. By responding “No” the DIYer ascertains that he/she has that tool or piece of equipment at their disposal for their home renovation project. By the DIYer responding with a “Yes”, he/she is instructing the program and its databases and information filtering system that those tools are required to complete their home renovation project. This final checklist query system is illustrated in the “Checklist for Equipment Requirements” worksheet of FIG. 12.

The Checklist (for the paint module) interacts with a Tool and Equipment Database, which is embodied as a Glossary that is set forth at the end of this description. This database also contains a glossary of definitions of relevant tools and equipment.

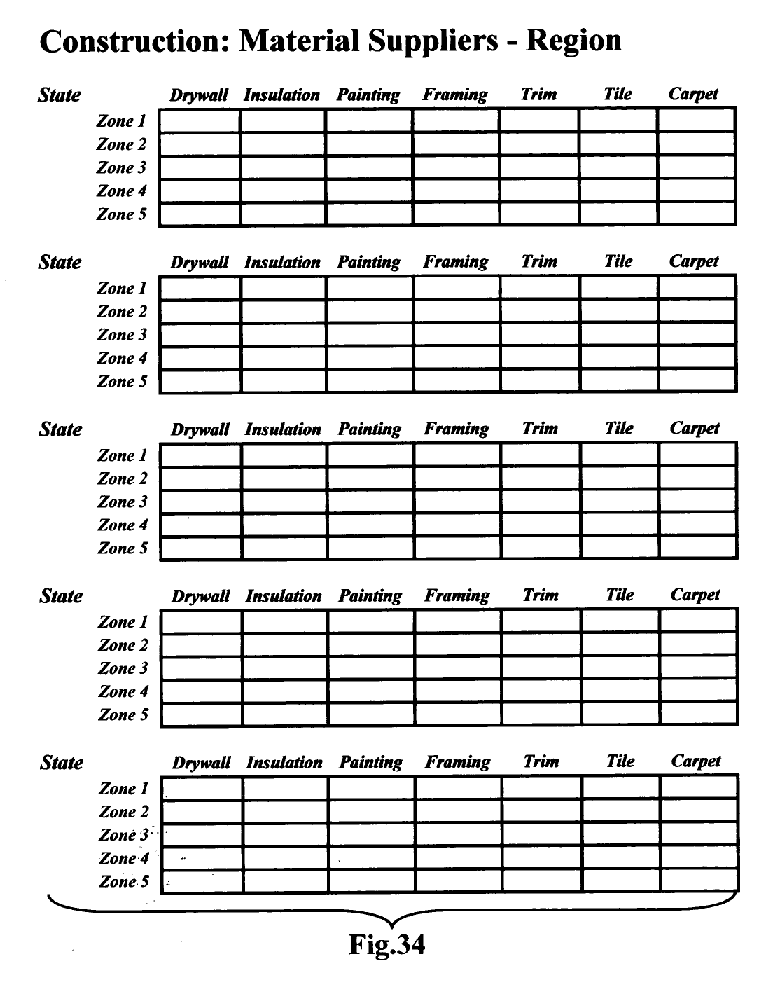

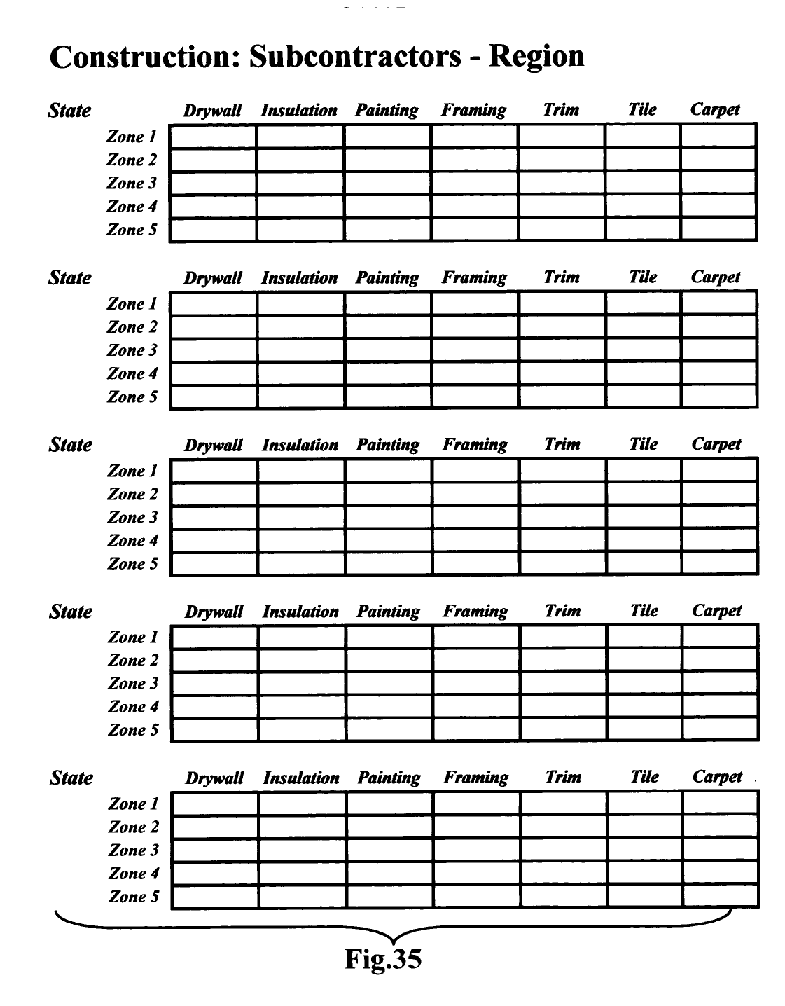

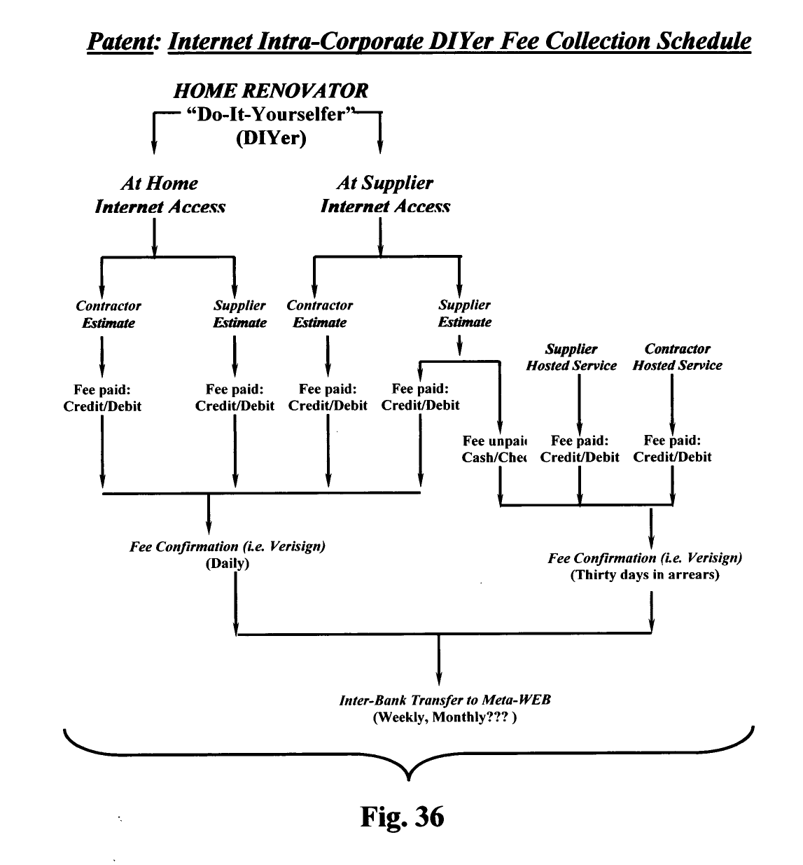

The Checklist (for the Paint Module, et al) draws its information from the material requirements and physical areas that the home renovator is going to complete for his/her project. The Checklist for Tools and Equipment (see FIG. 12) ascertains the proper tool usage by filtering the information provided by DIYer in the opening questions (FIGS. 4 and 5). The filtered information is, then, sent through the Glossary, which defines the specific materials to be used and the locations at which they are to be used. Then, the present invention filters all of the definitions in the Glossary, and selects the proper tool or piece of equipment to be used by the DIYer for his/her project. FIG. 29 defines examples of how the questions answered previously by the user (see FIGS. 3 to 12) interact with the Glossary of Definitions to produce the answers to the questions for tool and equipment requirements. A report is issued to the DIYer after all of the information pertaining to the tool and equipment requirements interfaces with a supplier's tools and equipment database for product identification and cost. See, i.e., FIGS. 30 to 32. The report will, then, be issued from the supplier to the DIYer and will show the tools and equipment indicated by the DIYer as being required to be ordered from the supplier with the corresponding cost. See FIG. 32. The input template (database) for use by the supplier to input all of the supplier's tools and equipment information identification and cost is depicted, for example, in FIG. 31.

### Databases

The databases that are used throughout the present invention have been discussed at length. To further clarify use of the databases, the rudimentary workings of a filtering system are explained, as it pertains to estimating the cost of materials, labor, tools, and equipment for an individual project for the DIYer. When the question portion of the present invention is enabled by the DIYer initially, the program breaks down each response to a question from the DIYer into the relevant database. Therefore, for simplicity, the response will target the proper database, which, in turn, will provide the correct response to the DIYer through, for example, manufacturer's specifications.

This example can be viewed in the first instance with the material database 70 (see FIG. 1). The database structure for material entry is depicted, for example, in FIGS. 46 and 47. All of the materials that are supplied by the supplier are in entered into this database with a corresponding product identification, cost, etc. Once all of the material is identified by the Q & A system, a report will be issued to the DIYer, as shown in FIGS. 48 and 49, where the quantities and cost for the individual materials required is broken down.

The next two major databases pertain to Tools & Equipment, one database relating to purchase of tools and equipment 80, and the other relating to rental of tools equipment 90. (See FIG. 1). These databases contain information relating to all of the tools that the supplier will sell or rent. As previously shown by the DIYer answering the opening questions he/she will enable the invention to filter through the database choose the tools and equipment the DIYer will require for his/her project either through rental or purchase. FIGS. 30 and 31 show the structure of the databases in which the supplier lists the tools and equipment. When the DIYer answers the questions in FIG. 12, he/she enables the programs to sort through the tools that are required for the project and only list those that the DIYer requires because he may have the remainder of the tools in his/her workshop. The filtered information will be presented to the DIYer in a report as per example FIG. 32.

Another major database is the one that contains information about the contractor/subcontractor 100 and their labor cost broken down into a square foot multiplier. All of the necessary information is acquired from the contractors/subcontractors that are interested in becoming part of the service the present invention supplies to the DIYer. If the DIYer decides that the level of difficulty of the project is too much for them or they may just want to supply the material for their project they simply give a positive response to the question whether or not they require a contractor/subcontractor to do the labor portion of their project. The DIYer is, then, required to pay a nominal fee (which is reimbursed to him if he chooses one of the contractors submitted to DIYer) and the DIYer is supplied with a list of, for example, four to six contractors/subcontractors in his/her area who have the proper insurance and licenses (where applicable) to do the project. The DIYer will also receive a budget price for the labor portion of the project that is based on the estimate completed by the DIYer.

### Programs

The body of the estimating programs (alphanumeric and graphic) are linked and accessed through the room shapes, which are represented in the screen capture of FIGS. 6 and 14. The estimating calculations for the ceiling area for the shapes are shown in FIGS. 15 and 16. Once the room shape is designated by the DIYer. The next screen for the ceiling screen capture (see FIG. 1 1) lets the DIYer input the wall dimensions for each wall in the dropdown box containing numeric choices in imperial or metric. The alphanumeric formulas located FIGS. 15 and 16 will calculate the area of the ceiling. When complete, the total area (square footage) is, then, sent to the database that is used to accumulate that specific item. It is just one of the totals that is used to figure out the amount material (or cost of labor if applicable) that is required for the DIYer's home renovation project.

The alphanumeric formulas used for calculating the wall areas are arrived at in a very similar fashion. After the DIYer enters the Room Shape he wants to use (FIG. 6), he/she is then taken to the next screen (see FIG. 7). The DIYer inputs the corresponding wall dimensions after highlighting the particular wall area in the graphic at the upper left. After completing the dimension-input stage, the dimensions are sent to the alphanumeric (or graphic where applicable) formula database in FIG. 20 for processing. The square footages that are computed are, then, sent to the cumulative databases as described above. After the square footages are sent to the proper database for accumulating the individual total areas for each different product (or color), the totals are subject to deductions by the opening area deductions that were provided from the opening specifications. See FIGS. 9 and 10.

Some of the estimating engines are not only alphanumeric in structure, but also have the capacity to depict graphically the installation of the products on the walls, ceilings, and floors as required by the DIYer. The graphic engines use the same inputs made by the DIYer in FIGS. 7, 9, 10, and 11 and convert the entries into algorithms by programming methods described in Drywall 1.0, “A software package for Optional Drywall Installation,” Sep. 17, 1996, R. Caron, C. DiGiacomo, T. Braithwaite & K. Roy. The present invention, then, depicts the installation of the material as shown in the examples on pages 1 to 23 of Drywall 1.0 and in the drywall installation example set forth below. These installation depictions (“construct by the numbers”) can have a significant effect in diminishing the amount of waste that is produced from completing construction projects. The savings to the economy by reducing waste have been spoken to by environmentalists at great length. The graphic depictions of the present invention also provide the DIYer with a roadmap to complete his/her home renovation project. This gives the DIYer the confidence to complete the project in a shorter period of time and in a professional manner.

### Reports

The reporting segment of the present invention addresses numerous requirements of the DIYer. First, the reports structure as shown in FIGS. 48 and 49 will provide the DIYer with a precise approximation of his/her material requirements and the cost of those requirements from their supplier. As examples of the further sophistication of the present invention, the DIYer is able to obtain graphical layouts of the materials required for his/her project, as illustrated in the insulation and drywall installation examples below, in a “construction by the numbers” form how to apply those materials and what to do with the usable pieces. The present invention also issues reports, for example, in the form illustrated in the insulation and drywall installation examples below for the DIYer's use. These reports are an accompaniment to the main reports generated, for example, the quantity of materials needed and cost of those materials from a given supplier.

Through the same database filtering mechanisms as discussed above, the present invention also supplies the DIYer with a list of tools and equipment that he/she will require for their project. The list takes into consideration the tools and equipment the DIYer already owns or has access to and, therefore, does not need to purchase the tools. The report generated provides the prices for purchasing the needed tools or a rental price of those tools.

The final major report lies in an option that the DIYer can choose if he/she does not want to do the labor portion of their home renovation project. If the DIYer chooses to employ a contractor/subcontractor, for a nominal fee, the DIYer is given a choice of a group of contractor/subcontractors in their geographic area. Preferably, these contractor/subcontractors have the proper insurance and licenses and will be available for viewing by the DIYer. The DIYer is also supplied with a budgeted labor cost for their home renovation project. The labor budget cost that is supplied to the DIYer is derived from an average of the square foot price provided by the contractor/subcontractors and the total square footage of the DIYer's project.

In the delivery of the aforementioned reports, the DIYer is provided with a cover page having the manufacturer's specifications for the product(s) that the DIYer is using for his/her project. The specification sheet will give the DIYer information about the corresponding government approvals for the product(s) that the DIYer selected. Such communication permits the manufacturers to have an ability to target a market “one to one.”

### Profit Distribution System

Another aspect of the present invention puts into place a structure to not only facilitate monetary tracking within the estimation system, but also the retrieval, banking and subsequent distribution of revenue received from the DIYers.

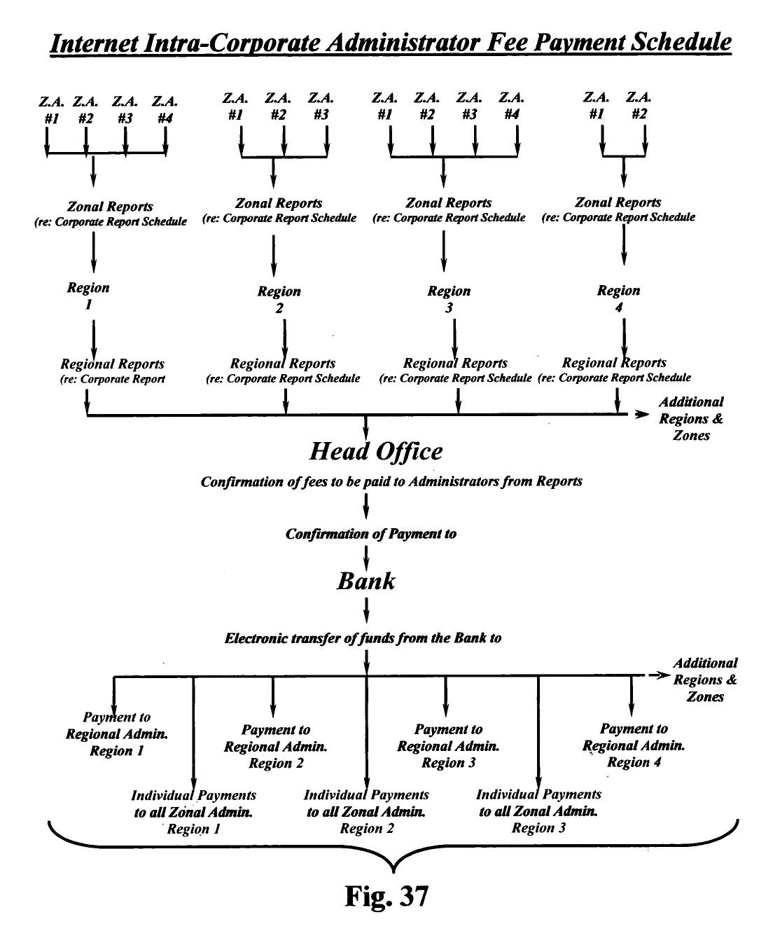

FIG. 33 illustrates, in the form of a flow chart, the organizational structure of the method of the present invention. A Head Office 110 administers the estimation system of the present invention and oversees its entire operation, including providing the computer system and measures for providing the system on the Internet 30 (see FIG. 1). The Head Office 110 receives all fees from the DIYers, both from the DIYer using the supplier's Internet site and from the user obtaining the information from their own residence. These fees are automatically transferred to the Head Office's bank account 170 by electronic transfer (i.e., VERISIGN®, PAYPAL®, AUTHORIZE^{SM}, etc.). The Head Office 110 maintains a detailed Internet-based spreadsheet that is directly interfaced through its own secured website with the Regional Administrators 120 and Zonal Administrators 130, the spreadsheet system tracking all fee payments, bank transfers, and receivables on a daily basis. The system registers every project that is estimated through any location, including the suppliers' sites or at the DIYer's residence. An invoice is issued to each supplier at the end of the month, which invoice indicates that particular supplier's daily usage, which projects were paid for by credit or debit cards, and which projects were paid for by cash or check. The projects that were paid for by check or cash will be invoiced automatically to the supplier (by the system) and the supplier will pay for the usage by electronic bank transfer within 30 days from the end of the month. A copy of the supplier invoiced amount payment system is automatically sent to the Zonal Administrators 130, the Regional Administrators 120, and the Head Office 100. The Head Office 110, then, electronically transfers to the Zonal Administrators 130 and the Regional Administrators 120 a payment amount based on a percentage of each dollar received from the DIYer, as defined by contracts 140 on a monthly basis.

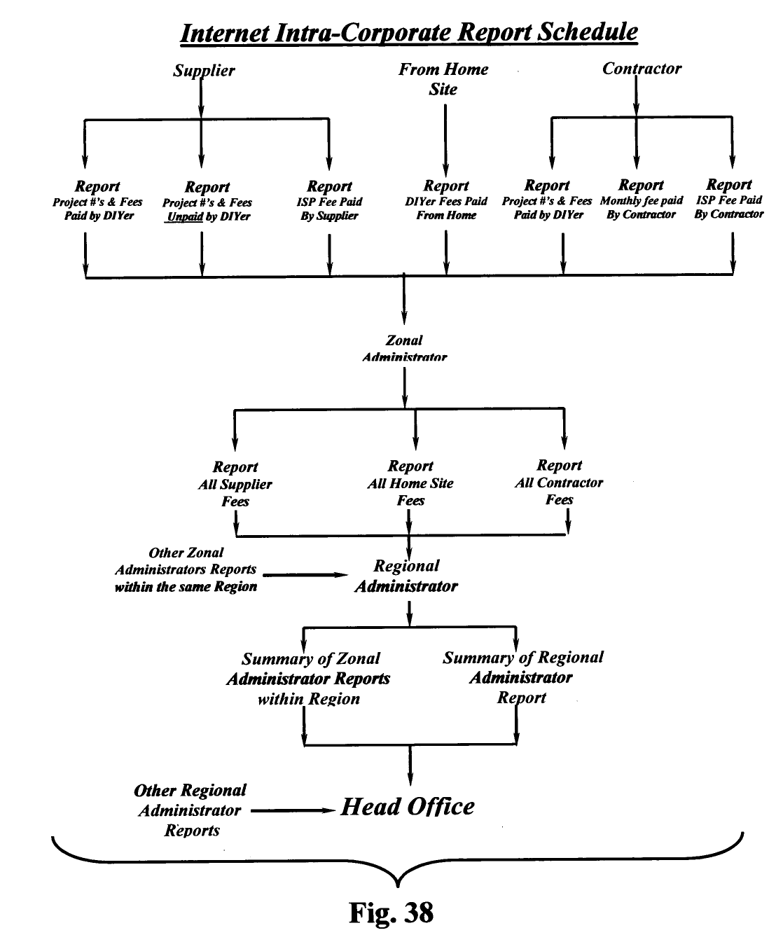

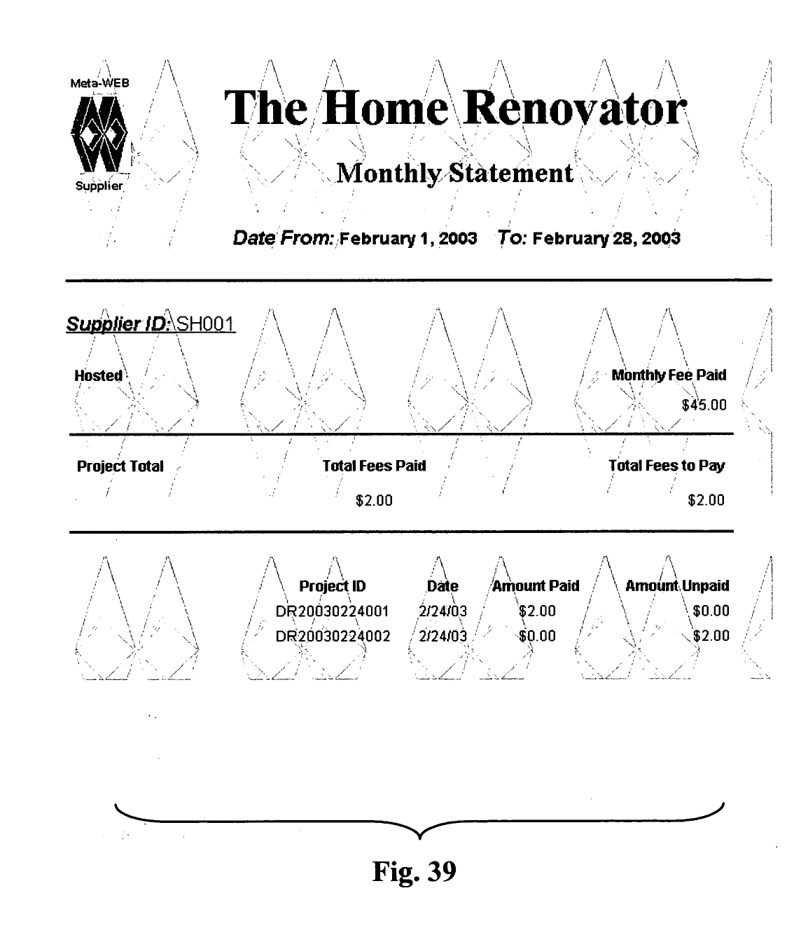

The Regional Administrators 120 are defined by large geographic regions. For example, North America is broken up into groups of regions, the United States having ten regions and Canada having three regions. The Regional Administrators 120 are responsible for coordination of Zonal Administrators 130 within the Regional Administrators' 120 respective region(s) and are responsible for creation, coordination, and maintenance of the supplier and contractor associates databases 150, 160 in their respective region(s). Examples for these databases are illustrated, for example, in FIGS. 34 and 35. The Regional Administrators 120 have an Internet-based regional detailed spreadsheet system so they may track all of the fee payments, bank transfers, and receivables from the Zonal Administrators 130 on a daily basis.

Each region is divided up into a number of zones. The zones are determined by a number of factors: some of which are population concentration, construction activity, etc. Zonal Administrators 130 are the front line troops for securing and maintaining the supplier and contractor associates 150, 160 in their respective zone. The Zonal Administrators 130 also have an Internet-based zonal detailed spreadsheet to track all of the fee payments, bank transfers, and receivables from the supplier and contractor associates in their zone on a daily basis.

Supplier associates 150 are associated with a respective zone and each are electronically connected to the Head Office 110 and a respective Regional Administrator 120 and Zonal Administrator 130 through detailed Internet-based spreadsheets and invoices so all fees paid by credit and debit cards (via banking institutions 170) and the receivables paid by cash or check can be monitored on a daily basis. Receivables that are received in cash or by check from DIYer will be invoiced and transferred electronically on monthly basis to/from the Head Office 110.

Contractor Associates 160 are associated with a respective zone and each are electronically connected to the Head Office 110 and a respective Regional Administrator 120 and Zonal Administrator 130 so all fees paid can be monitored on a daily basis.

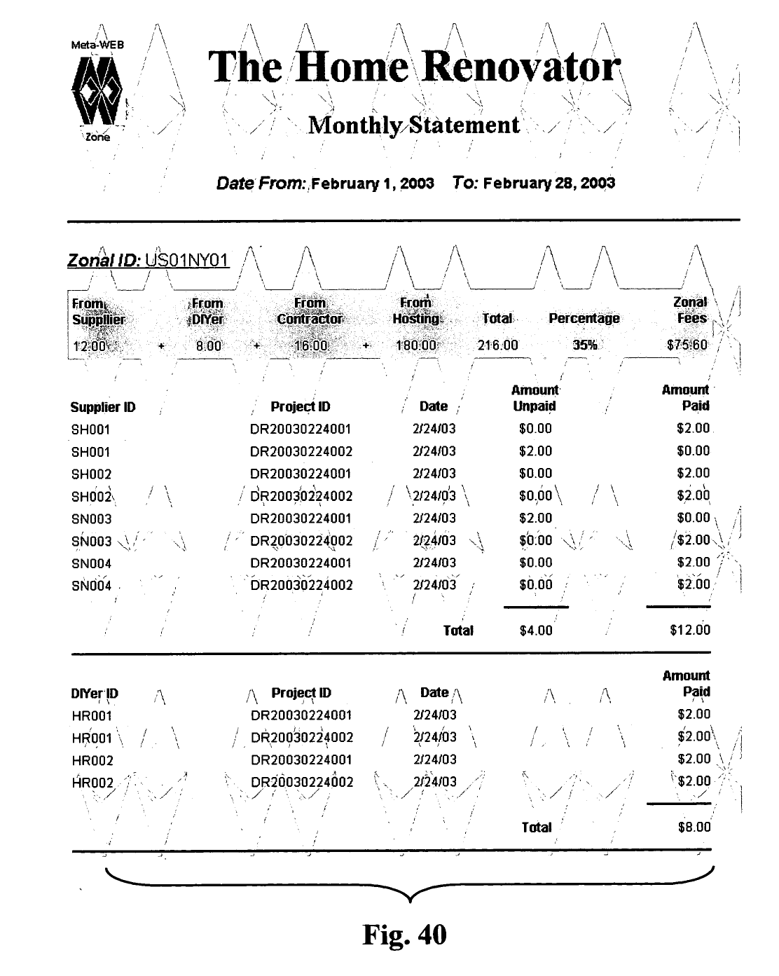

The series of flowcharts in FIGS. 36 to 38 are used to help understand the method of the present invention and to show the sales and purchase structure. Also explained are the types of reports, with their relevant information, that will be issued at each level. In FIG. 36, the user 1 (in this case, the DIYer) accesses the construction software estimating programs either at home 10 or at a local supplier 20. The DIYer is able obtain his/her estimate for the quantity of material or the cost of labor simply by using their credit card for fee payment prior to using the program. If the estimating program is accessed at the supplier 20, the fee is nominal, for example, $2.00 for an alphanumeric estimate and $4.00 for a graphical estimate. If the DIYer performs the material estimation from their own home 10, then the fee is greater, for example, $10.00. Also, as noted in FIG. 36, the DIYer can obtain a labor estimate from a local contractor from either their home 10 or from the supplier 20. Each time the DIYer wants to estimate a home renovation project, they are issued a new project identification number. These project numbers are unique integers only increasing in numerical sequence. The unique project identification number will form the basis for tracking all revenue and also form the basis for all subsequent payments to the Zonal and Regional Administrators 120, 130. Companies 200 providing such services verify payment of fees. The funds are, then, transferred electronically to a banking institution 210 for deposit to the Head Office's account 210.

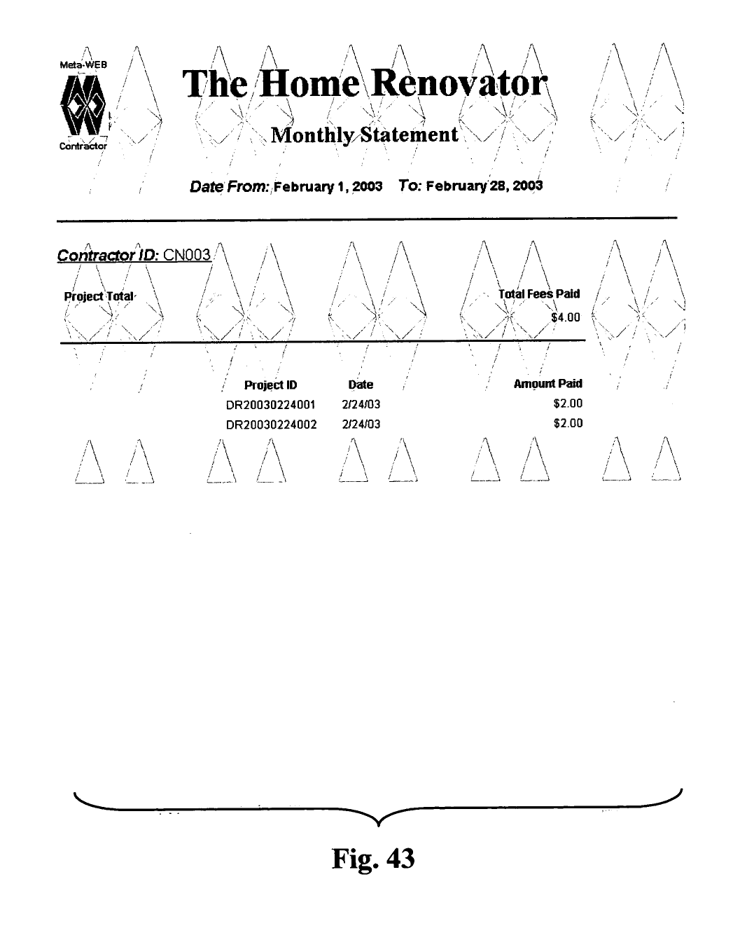

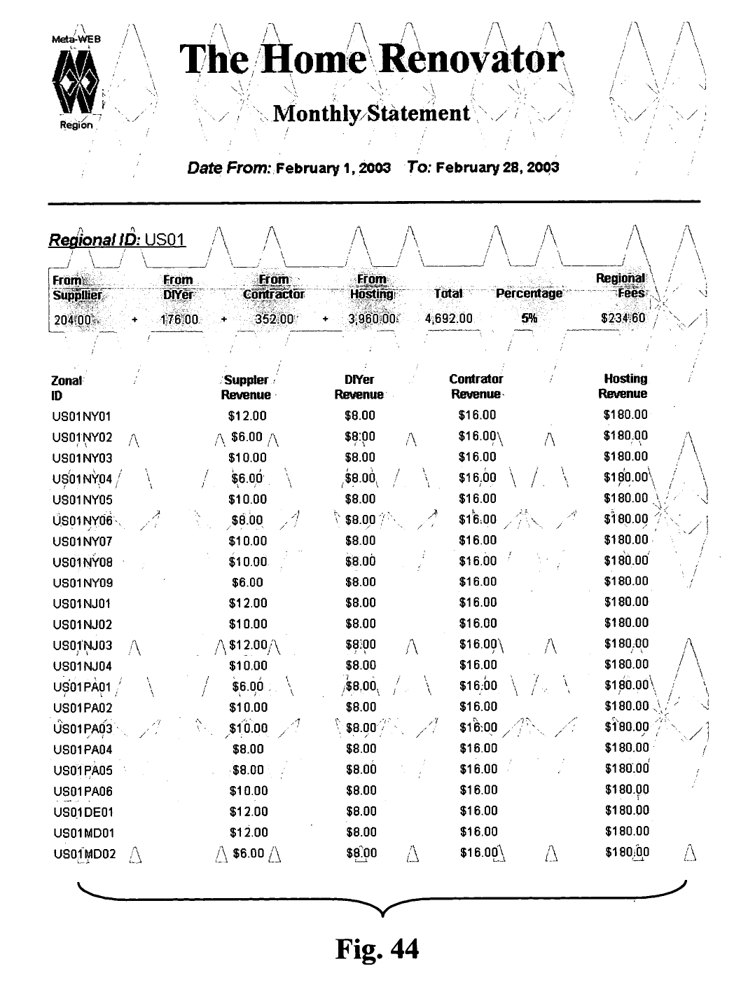

It is noted that not all payments are made on a daily basis. A delayed payment 220 takes place if the DIYer pays by cash or check at the supplier 20 or if the supplier decides to use the software as a sales tool to attract the DIYers and, therefore, the supplier pays the fees, presumably at a later date. The supplier's payment of the delayed fee to the Head Office 110 is, preferably, to be paid within fifteen days after the end of the month. The payment is based on the monthly report that the supplier receives automatically from the estimation system, which report separates projects that were paid for by the DIYer and projects that were not. Examples of such reports are found in FIGS. 39 and 40. The remaining fees 230, 240 that are to be paid to the Head Office 110 by the suppliers and contractors depend upon whether or not the Head Office 110 hosts the web service 180 (see FIG. 33) on the Internet for the particular supplier. The payments of fees are verified by a verification company 250 and, then, are transferred electronically to a banking institution 210 for deposit to the Head Office's 110 account.

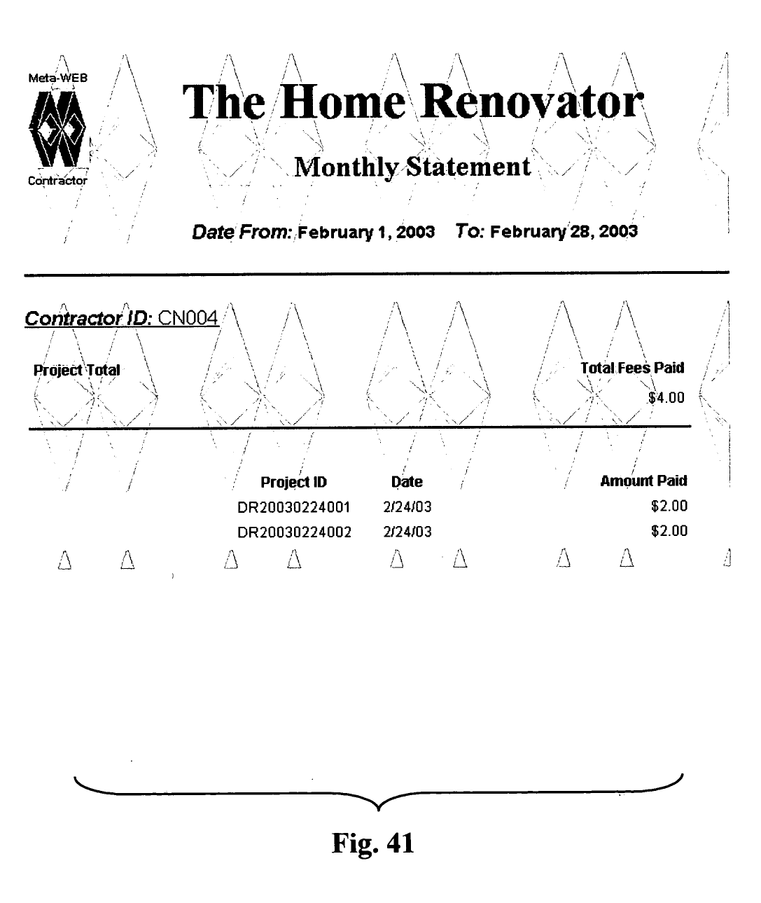

The most significant aspects of the present invention are the reports and the corporate structure. FIG. 37 illustrates the corporate structure from bottom to top. The Zonal Administrators 300 form the first level of the corporate structure, whose responsibilities include locating, contacting, and administering the estimation system's services to their respective local suppliers and contractors. The next level of the corporate structure is formed by the Regional Administrators 310. As set forth above, ten regions can form the United States, each region being made up of a number of states. An example of this is a Metropolis Region, which includes New York, Pennsylvania, New Jersey, Delaware, and Maryland. The Regional Administrator 310 has the responsibility of determining how many Zones he/she will need to administer his/her region and will also choose the particular Zonal Administrators 300 that administrate those zones. The Head Office 320 has the responsibility of locating and employing the Regional Administrators 310, approving appointment of the Zonal Administrators 300, contracting with the Regional and Zonal Administrators 300, 310, and approving disbursement of all fees through the Bank 330. The Bank 330 electronically transfers 340 all approved funds to the Zonal and Regional Administrators 300, 310.

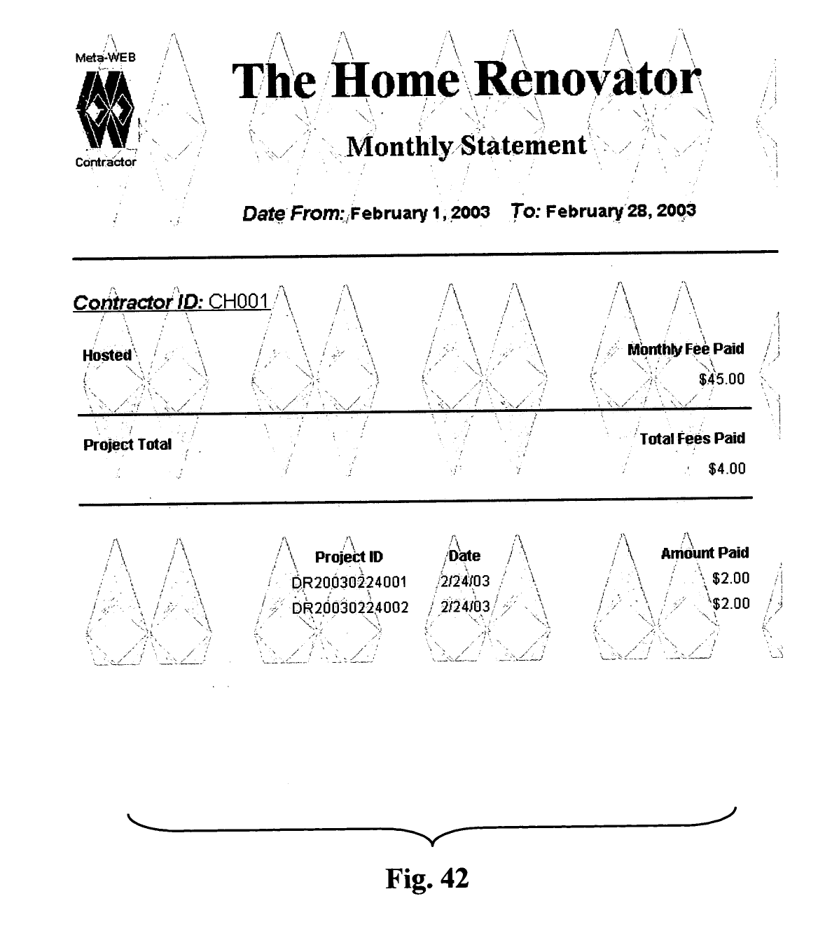

FIG. 38 illustrates the reporting system that starts at the home renovator level for access to the estimating system on the Internet, which can be accomplished either at home or at a supplier. As shown in FIG. 36, the estimation system tracks the collection of fees from the DIYer through the various channels. FIG. 37 illustrates the overall corporate structure for the complete cycling of the revenue from the DIYer back to the payment of fees to the Zonal and Regional Administrators 300, 310. Finally, FIG. 38 encapsulates the makeup of the various reports as they are automatically generated at the end of every payment period, preferably, every month. The top of FIG. 38 illustrates three revenue generating areas: Supplier 400, Home 410, and contractor 420. Three types of reports 430 are generated based upon a supplier-initiated estimation, one report 440 is generated based upon a DIYer home estimation, and three types of reports 450 are generated based upon a contractor-initiated estimation. Each report 430, 440, 450 includes information regarding a particular month's projects by number and date, which projects were paid, and which projects were unpaid.

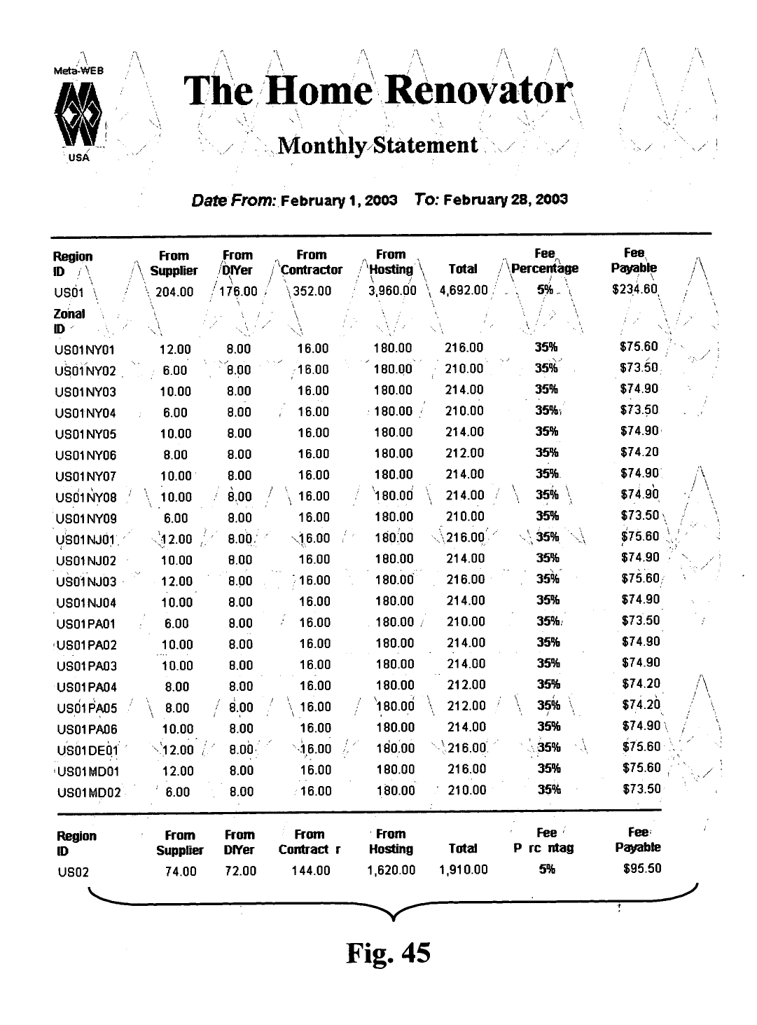

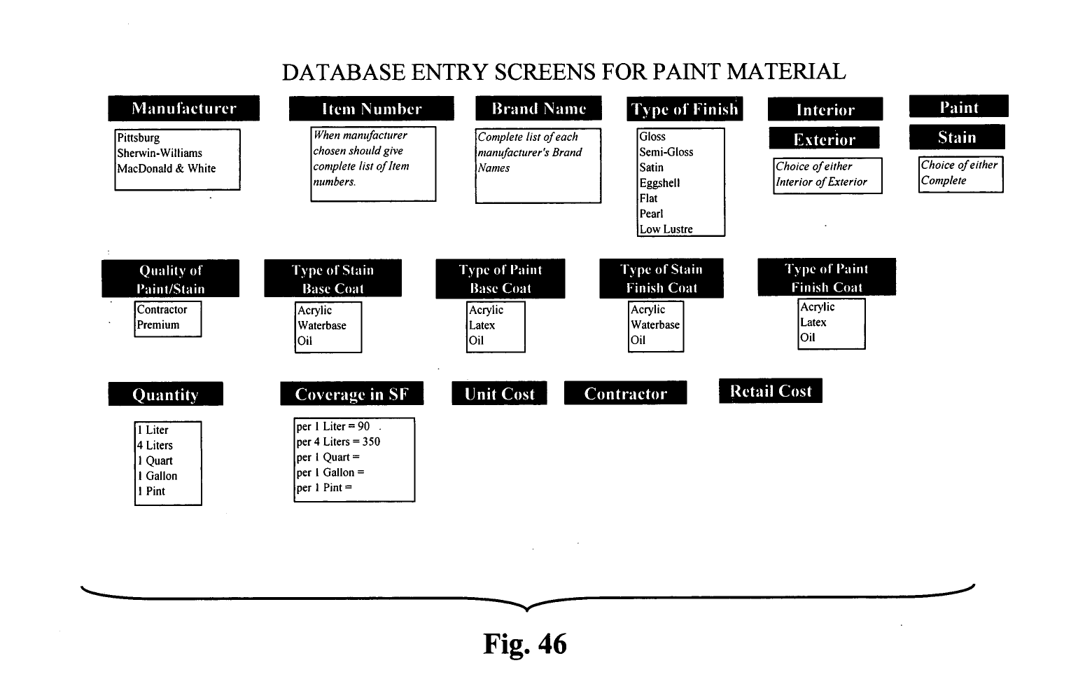

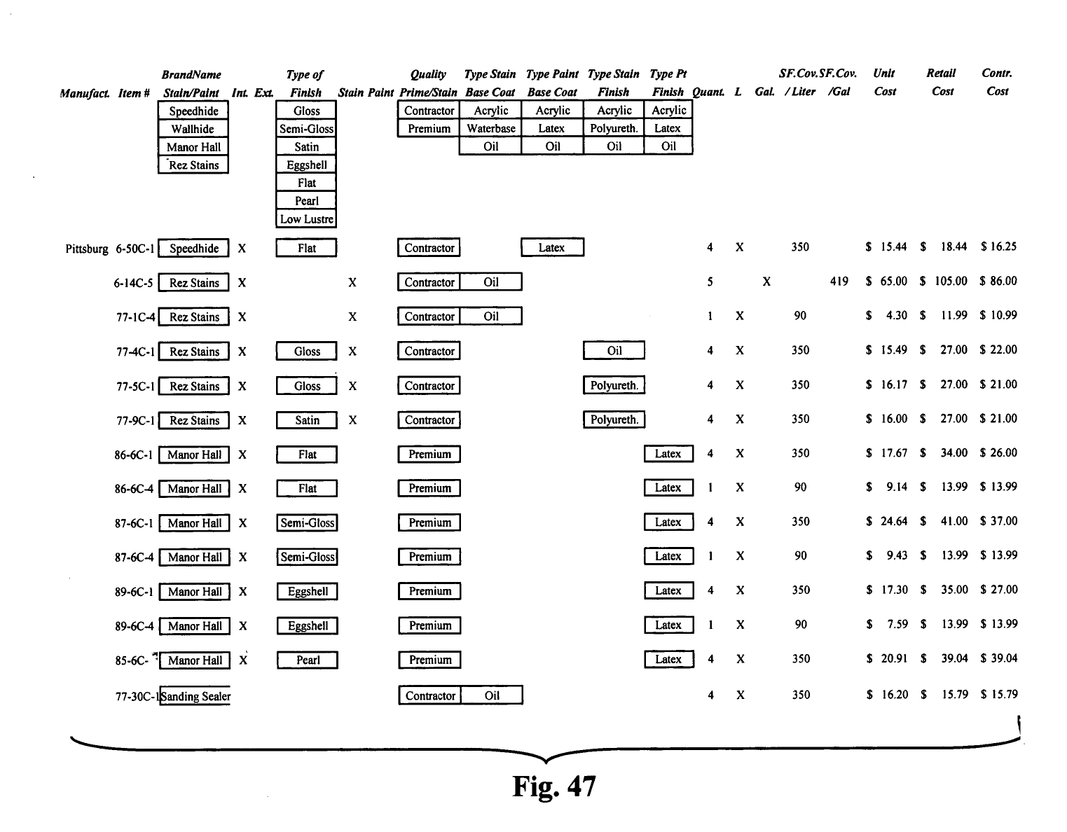

A Supplier Report, illustrated in FIG. 39, summarizes the total projects paid and unpaid for a given supplier indicating the amount of unpaid project fees to be electronically transferred. The Supplier Report also shows that the hosting fee paid has been paid for the previous month, which has been completed through pre-authorized payment through electronic transfer. At the same time that the Supplier Report is issued to the supplier, the same information is issued to their respective local Zonal Administrator and summarized in the Zonal Report, which is illustrated in FIG. 40. If the home renovator 1 accesses the Internet from their home 410, a report 440 is issued to the Zonal Administrator 460, the context and form of which is illustrated in FIG. 41. The final area of the revenue stream is the contractor 420. Reports relating to the contractor 420 and issued to the Zonal Administrator 460 are illustrated in FIGS. 42 and 43.

The Zonal Administrator 460 receives reports summarizing all of the fees 470 for a supplier 400, all of the fees 480 collected from the DIYer 410 from home access, and all of the fees 490 for a contractor 420. A report of these fees is illustrated in the Home Renovator Monthly Statement of FIG. 40. There is a summary at the top of the Report in which all of the fees are totaled for the various originating areas (i.e. suppliers, contractors, etc.). The individual totals are added together to show the grand total of revenue earned by the Zonal Administrator 460. The grand total is multiplied by a commission percentage, which is the Zonal Administrator's fee for services rendered. The Zonal Administrator's percentage can be, for example, thirty five percent, which is the amount he/she will receive for the month of that Report.

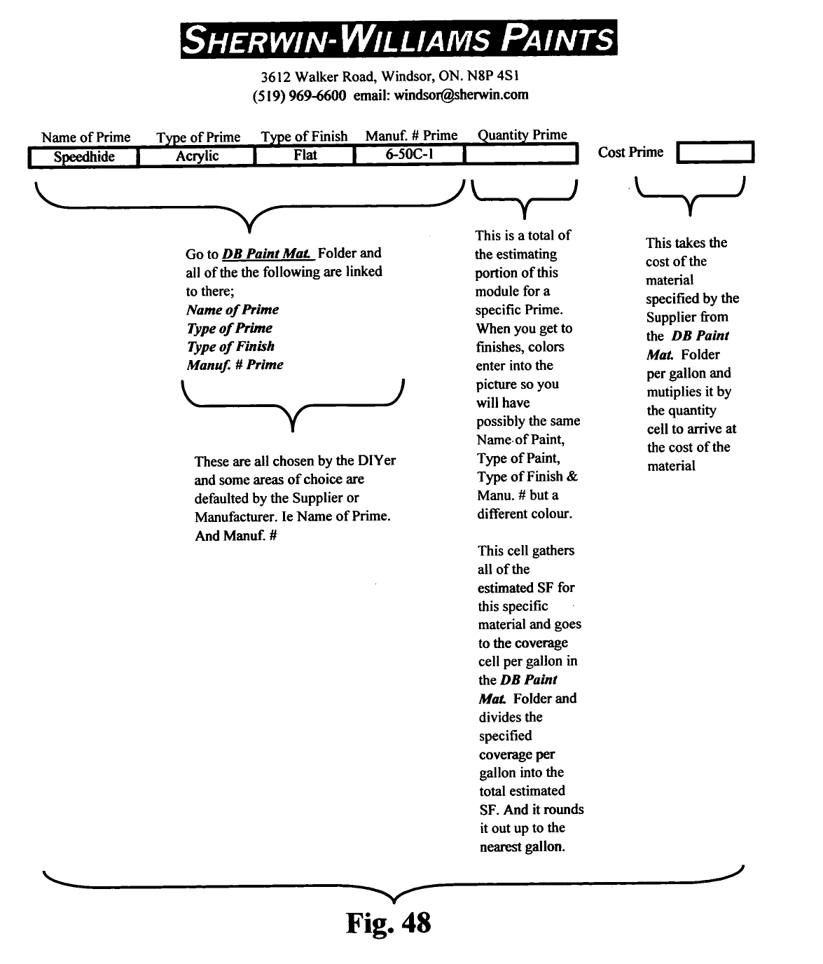

All of the reports 470, 480, 490 to the Zonal Administrators 460, are simultaneously sent to the respective Regional Administrator 500. A report is issued to Regional Administrator 500, which summarizes all of the reported revenue form the various zones within the specified region, an example of which is found in FIG. 44. This report has a summary at the top in which all of the fees are totaled from the various zones of that particular region. The individual zonal totals are added together to show the grand total of revenue earned by the Regional Administrator 500. The grand total is multiplied by a commission percentage, which is the Regional Administrator's 500 fee for services rendered. The Regional Administrator's percentage can be, for example, five percent which is the amount he/she will receive for the month that Report.

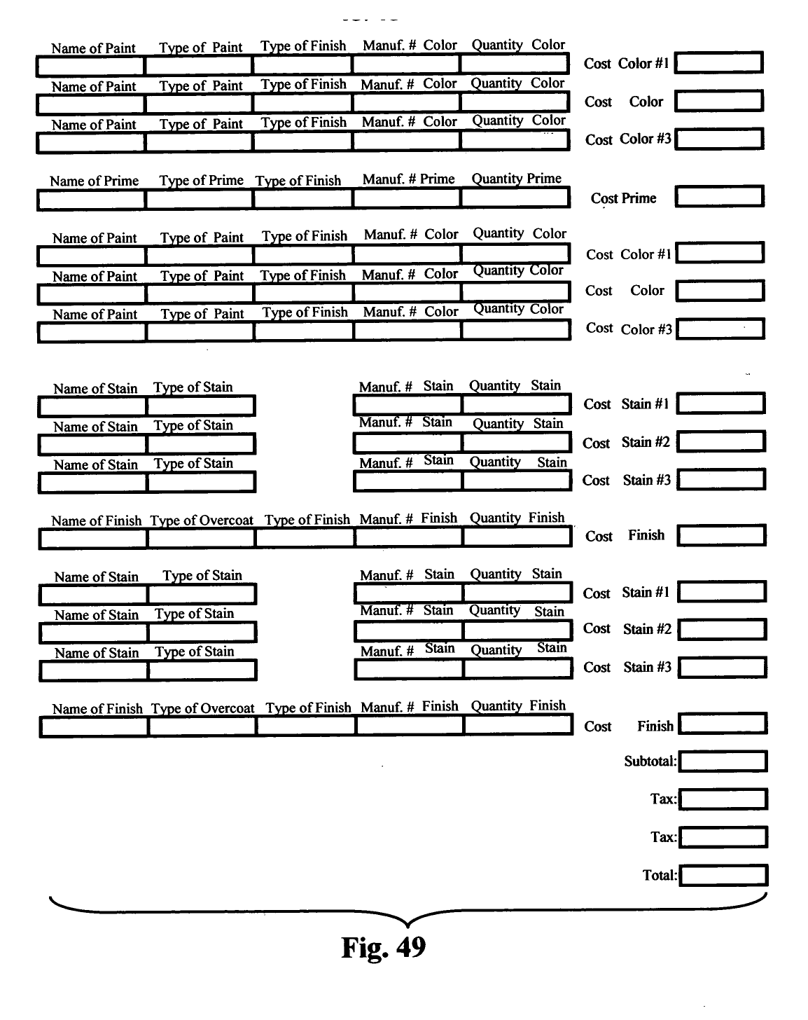

Finally, the system of the present invention simultaneously electronically transmits a summary 510 of Zonal Administrator Reports 470, 480, 490 and a summary 520 of Regional Administrator Reports 520 to the Head Office 530, an example of which is illustrated in FIG. 45, which summarizes all of the fees that have to be electronically transmitted to all of the Zonal and Regional Administrators 460, 500 in the country in question.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A method for estimating renovation, which comprises:
inputting information regarding a user's construction project into a computer-based information processing system; and
producing with the processing system a report custom-tailored with respect to the information provided by the user, the report containing:
descriptions of materials needed to complete the project;
quantities and cost of the materials;
descriptions of tools needed to complete the project; and
quantities and cost of the tools.

2. A method for estimating renovation, which comprises:
querying a user for information regarding the user's construction project with a computer-based electronic question-and-answer information processing system;
electronically parsing the information regarding the user's construction project with a computerized processing system having databases; and
producing with the processing system a report custom-tailored with respect to the information provided by the user, the report containing:
descriptions of materials needed to complete the project;
quantities and cost of the materials;
descriptions of tools needed to complete the project; and
quantities and cost of the tools.

3. The method according to claim 2, which further comprises providing the computer-based electronic question-and-answer information processing system as an Internet-based electronic question-and-answer information processing system.

4. The method according to claim 2, which further comprises providing access to the processing system from suppliers' stores or from users' residences.

5. The method according to claim 2, which further comprises providing the information processing system with sub-systems having question-and-answer input configurations for different kinds of constructions projects.

6. The method according to claim 5, which further comprises providing the information processing system with at least one sub-system selected from the group consisting of framing, insulation, drywall, acoustic, window, door, trim, tile, paint, flooring, roofing, brick, siding, stucco, fascia, soffit, eavestrough, stair, walkway, patio, driveway, fence, patio, porch, landscape, footing, fill, foundation, and wall.

7. The method according to claim 6, which further comprises providing the sub-systems with associated databases.

8. The method according to claim 2, which further comprises providing in the report at least one of volume, linear footage, and square footage of each of the needed materials.

9. The method according to claim 2, which further comprises providing in the report:
prices of the materials at user-geographically local suppliers; and
prices of the tools at the user-geographically local suppliers.

10. The method according to claim 2, which further comprises providing in the report:
names of contractors available to complete the project; and
budgeted cost for labor from each of the contractors.

11. The method according to claim 2, which further comprises providing in the report graphics indicating how at least some of the materials are to be installed.

12. A method for estimating renovation, which comprises:
accessing, by a user, an Internet-based computerized question-and-answer information processing system for estimating a user's construction project having at least one sub-project;
providing the processing system with sub-systems each relating to a predefined kind of construction project and with databases relating to the sub-systems;
selecting, by the user, at least one of the sub-systems relating to a sub-project; querying the user for information regarding the user's sub-project with a series of questions;
electronically parsing the information regarding the user's sub-project with the processing system;
producing with the processing system a report custom-tailored with respect to the information provided by the user, the report containing:
descriptions of materials needed to complete the project;
quantities and cost of the materials;
descriptions of tools needed to complete the project; and
quantities and cost of the tools.

13. The method according to claim 12, wherein the user's construction project has sub-projects and which further comprises repeating the selecting, querying, parsing, and producing steps for each of the sub-projects.

14. The method according to claim 12, which further comprises: querying the user for information regarding tools already available to the user with a series of questions; and
generating the descriptions of tools needed to complete the project and the quantities and cost of the tools based upon the provided information regarding the available tools.

15. A computerized method, which comprises executing the method according to claim 1 on a computer.

16. A computerized method, which comprises executing the method according to claim 2 on a computer.

17. A computerized method, which comprises executing the method according to claim 12 on a computer.

18. A computer-readable medium having computer-executable instructions for performing the method according to claim 1.

19. The medium according to claim 18, wherein the medium is a device selected from the group consisting of a ROM, a RAM, a floppy disk, a hard disk, a tape, a compact disc, and a digital video disk.

20. A computer-readable medium having computer-executable instructions for performing the method according to claim 2.

21. A computer-readable medium having computer-executable instructions for performing the method according to claim 12.

22. A computer memory having computer-executable instructions for performing the method according to claim 1.

23. A computer memory having computer-executable instructions for performing the method according to claim 2.

24. A computer memory having computer-executable instructions for performing the method according to claim 12.

25. An electric carrier signal carrying computer-executable instructions for performing the method according to claim 1.

26. An electric carrier signal carrying computer-executable instructions for performing the method according to claim 2.

27. An electric carrier signal carrying computer-executable instructions for performing the method according to claim 12.

28. A method for downloading a computer program for estimating renovation, which comprises:
providing an electronic data network; and
downloading the computer program according to claim 15 from the electronic data network to the computer.

29. The method according to claim 28, wherein the electronic data network is the Internet.

30. A method for downloading a computer program for estimating renovation, which comprises:
providing an electronic data network; and
downloading the computer program according to claim 16 from the electronic data network to the computer.

31. A method for downloading a computer program for estimating renovation, which comprises:
providing an electronic data network; and
downloading the computer program according to claim 17 from the electronic data network to the computer.
